(19) United States
(12) Patent Application Publication
(10) Pub. No.: US 2020/0403818 A1
(43) Pub. Date: Dec. 24, 2020

(54) GENERATING IMPROVED DIGITAL TRANSCRIPTS UTILIZING DIGITAL TRANSCRIPTION MODELS THAT ANALYZE DYNAMIC MEETING CONTEXTS

(71) Applicant: Dropbox, Inc., San Francisco, CA (US)

(72) Inventors: Shehzad Daredia, San Francisco, CA (US); Behrooz Khorashadi, Mountain View, CA (US)

(21) Appl. No.: 16/587,424

(22) Filed: Sep. 30, 2019

Related U.S. Application Data
(60) Provisional application No. 62/865,623, filed on Jun. 24, 2019.

(51) Int. Cl. H04L 12/18; G06F 16/34; G06N 20/00; G10L 15/26

(52) U.S. Cl. CPC H04L 12/1831; H04L 12/1818; G10L 15/265; G06F 16/345; G06N 20/00; H04L 12/1822

(57) ABSTRACT

The present disclosure relates to systems, non-transitory computer-readable media, and methods for improving digital transcripts of a meeting based on user information. For example, a digital transcription system creates a digital transcription model to automatically transcribe audio from a meeting based on documents associated with meeting participants, event details, user features, and other meeting context data. In one or more embodiments, the digital transcription model creates a digital lexicon based on the user information, which the digital transcription system uses to generate the digital transcript. In some embodiments, the digital transcription model trains and utilizes a digital transcription neural network to generate the digital transcript.

### CROSS-REFERENCE TO RELATED APPLICATIONS

This application claims the priority to and the benefit of U.S. Provisional Patent Application No. 62/865,623, filed Jun. 24, 2019, which is incorporated herein by reference in its entirety.

### BACKGROUND

Recent years have seen significant technological improvements in hardware and software platforms for facilitating meetings across computer networks. For example, conventional digital event management systems can coordinate digital calendars, distribute digital documents, and monitor modifications to digital documents across computer networks before, during, and after meetings across various computing devices. Moreover, conventional speech recognition systems can generate digital transcripts from digital audio/video streams collected between various participants using various computing devices.

Despite these recent advancements in managing meetings across computer networks, conventional systems have a number of problems in relation to accuracy, efficiency, and flexibility of operation. As one example, conventional systems regularly generate inaccurate digital transcriptions. For instance, these conventional systems often fail to accurately recognize spoken words in a digital audio file of a meeting and generate digital transcripts with a large number of inaccurate (or missing) words. These inaccuracies in digital transcripts are only exacerbated in circumstances where participants utilize uncommon vocabulary terms, such as specialized industry language or acronyms.

Conventional systems also have significant shortfalls in relation to efficiency of implementing computer systems and interfaces. For example, conventional systems often generate digital transcripts with non-sensical terms throughout the transcription. Accordingly, many conventional systems provide a user interface that requires manual review of each word in the digital transcription to identify and correct improper terms and phrases. To illustrate, in many conventional systems a user must re-listen to audio and enter corrections via one or more user interfaces that include the digital transcription. Often, a user must correct the same incorrect word in a digital transcript each time the word is used. This approach requires significant time and user interaction with different user interfaces. Moreover, conventional systems waste significant computing resources in producing, reviewing, and resolving inaccuracies in digital transcripts.

In addition, conventional systems are inflexible. For instance, conventional systems that provide automatic transcription services have a predefined vocabulary. As a result, conventional systems rigidly analyze audio files from different meetings based on the same underlying language analysis. Accordingly, when participants use different words across different meetings, conventional systems misidentify words in the digital transcript based on the same rigid analysis.

These along with additional problems and issues exist with regard to conventional digital event management systems and speech recognition systems.

### SUMMARY

Embodiments of the present disclosure provide benefits and/or solve one or more of the foregoing or other problems in the art with systems, non-transitory computer-readable media, and methods for improving efficiency and flexibility by using a digital transcription model that detects and analyzes dynamic meeting context data to generate accurate digital transcripts. For instance, the disclosed systems can analyze audio data together with digital context data for meetings (such as digital documents corresponding to meeting participants; digital collaboration graphs reflecting dynamic connections between participants, interests, and organizational structures; and digital event data reflecting context for the meeting). By utilizing a digital transcription model based on this dynamic meeting context data, the disclosed systems can generate digital transcripts having superior accuracy while also improving flexibility and efficiency relative to conventional systems.

For example, in various embodiments the disclosed systems generate and utilize a digital lexicon to aid in the generation of improved digital transcripts. For example, the disclosed systems utilize a digital transcription model that generates a digital lexicon (e.g., a specialized vocabulary list) based on meeting context data (e.g., based on collections of digital documents utilized by one or more participants). The disclosed systems can utilize this specialized digital lexicon to more accurately identify words in digital audio and generate more accurate digital transcripts.

In some embodiments, the disclosed systems train and employ a digital transcription neural network to generate digital transcripts. For instance, the disclosed systems can train a digital transcription neural network based on audio training data and meeting context training data. Once trained, the disclosed systems can utilize the trained digital transcription neural network to generate improved digital transcripts based on audio data input together with meeting context data.

Additional features and advantages of one or more embodiments of the present disclosure are provided in the description which follows, and in part will be apparent from the description, or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates a schematic diagram of an environment in which a content management system having a digital transcription system operates in accordance with one or more embodiments.

FIG. 2 illustrates a schematic diagram of generating a digital transcript of a meeting utilizing a digital transcription model in accordance with one or more embodiments.

FIG. 3 illustrates a diagram of a meeting environment involving multiple users in accordance with one or more embodiments.

FIG. 4A illustrates a block diagram of utilizing a digital lexicon created by a digital transcription model to generate a digital transcript in accordance with one or more embodiments.

FIG. 4B illustrates a block diagram of training a digital lexicon neural network to generate a digital lexicon in accordance with one or more embodiments.

FIG. 5A illustrates a block diagram of utilizing a digital transcription model to generate a digital transcript in accordance with one or more embodiments.

FIG. 5B illustrates a block diagram of a digital transcription neural network trained to generate a digital transcript in accordance with one or more embodiments.

FIG. 6 illustrates an example graphical user interface that includes a meeting document and a meeting event item in accordance with one or more embodiments.

FIG. 7 illustrates a sequence diagram of providing redacted digital transcripts to users in accordance with one or more embodiments.

FIG. 8 illustrates an example collaboration graph of a digital content management system in accordance with one or more embodiments.

FIG. 9 illustrates a block diagram of the digital transcription system with a digital content management system in accordance with one or more embodiments.

FIG. 10 illustrates a flowchart of a series of acts of utilizing a digital transcription model to generate a digital transcript of a meeting in accordance with one or more embodiments.

FIG. 11 illustrates a block diagram of an example computing device for implementing one or more embodiments of the present disclosure.

FIG. 12 illustrates a networking environment of the content management system operates in accordance with one or more embodiments.

### DETAILED DESCRIPTION

One or more embodiments of the present disclosure include a digital transcription system that generates improved digital transcripts by utilizing a digital transcription model that analyzes dynamic meeting context data. For instance, the digital transcription system can generate a digital transcription model to automatically transcribe audio from a meeting based on documents associated with meeting participants; digital collaboration graphs reflecting connections between participants, interests, and organizational structures; digital event data; and other user features corresponding to meeting participants. In some embodiments, the digital transcription system utilizes meeting context data to dynamically generate a digital lexicon specific to a particular meeting and/or participants and then utilizes the digital lexicon to accurately decipher audio data in generating a digital transcript. By utilizing meeting context data, the digital transcription system can efficiently and flexibly generate accurate digital transcripts.

To illustrate, in one or more embodiments, the digital transcription system receives an audio recording of a meeting between multiple participants. In response, the digital transcription system identifies a user that participated in the meeting. For the identified user (e.g., meeting participant), the digital transcription system determines digital documents (i.e., meeting context data) corresponding to the user. In addition, the digital transcription system utilizes a digital transcription model to generate a digital transcript based on the audio recording of the meeting and the digital documents of the user (and other users, as described below).

As mentioned, in some instances the digital transcription system utilizes a digital lexicon (e.g., lexicon list) to generate a digital transcript of a meeting. For example, the digital transcription system emphasizes words from the digital lexicon when transcribing an audio recording of the meeting. In various embodiments, the digital transcription model of the digital transcription system generates the digital lexicon from meeting context data (e.g., digital documents, client features, digital event details, and a collaboration graph) corresponding to one or more users that participated in the meeting. In alternative embodiments, the digital transcription system trains and utilizes a digital lexicon neural network to generate the digital lexicon.

In one or more embodiments, the digital transcription system dynamically generates multiple digital lexicons that correspond to different meeting subjects. Then, upon determining a given meeting subject for an audio recording (or portion of a recording), the digital transcription system can access and utilize the corresponding digital lexicon that matches the determined meeting subject. By having a digital lexicon that includes words that correspond to the context of a meeting, the digital transcription system can automatically create highly accurate digital transcripts of the meeting (i.e., with little or no user involvement).

In one or more embodiments, the digital transcription system utilizes the digital transcription model to generate the digital transcript directly from meeting context data (i.e., without generating an intermediate digital lexicon). For example, in one or more embodiments, the digital transcription system provides audio data of a meeting along with meeting context data to the digital transcription model. The digital transcription system then generates the digital transcript. To illustrate, in some embodiments, the digital transcription system trains a digital transcription neural network as part of the digital transcription model to generate a digital transcript based on audio data of the meeting as well as meeting context data.

When training a digital transcription neural network, in various embodiments, the digital transcription system generates training data from meeting context data. For example, utilizing digital documents gathered from one or more users of an organization, the digital transcription system can create synthetic text-to-speech audio data of the digital documents as training data. The digital transcription system feeds the synthetic audio data to the digital transcription neural network along with the meeting context data from the one or more users. Further, the digital transcription system compares the output transcript of the audio data to the original digital documents. In some embodiments, the digital transcription system continues to train the digital transcription neural network with user feedback.

As mentioned above, the digital transcription system can utilize meeting context data corresponding to a meeting participant (e.g., a user). Meeting context data for a user can include user digital documents maintained by a content management system. For example, meeting context data can include user features, such as a user's name, profile, job title, job position, workgroups, assigned projects, etc. Additionally, meeting context data can include meeting agendas, participant lists, discussion items, assignments, and/or notes as well as calendar events (i.e., meeting event items). In addition, meeting context data can include event details, such as location, time, duration, and/or subject of a meeting. Further, meeting context data can include a collaborative graph that indicate relationships between users, projects, documents, locations, etc. For instance, the digital transcription system identifies the meeting context data of other meeting participants based on the collaborative graph.

Upon transcribing a digital transcript, the digital transcription system can provide the digital transcript to one or more users, such as meeting participants. Depending on the permissions of the requesting user, the digital transcription system may determine to provide a redacted version of a digital transcript. For example, in some embodiments, while transcribing audio data of a meeting, the digital transcription system detects portions of the meeting that include sensitive information. In response to detecting sensitive information, the digital transcription system can redact the sensitive information from a copy of a digital transcript before providing the copy to the requesting user.

As explained above, the digital transcription system provides numerous advantages, benefits, and practical applications over conventional systems and methods. For instance, the digital transcription system can improve accuracy relative to conventional systems. More particularly, the digital transcription system can significantly reduce the number of errors in digital transcripts. Thus, by utilizing meeting context data, the digital transcription system can more accurately identify words and phrases from an audio stream in generating a digital transcript. For example, the digital transcription system can determine the subject of a meeting and utilize contextual relevant lexicons when transcribing the meeting. Further, the digital transcription system can recognize and correctly transcribe uncommon, unique, or made-up words used in a meeting.

As a result of the improved accuracy to digital transcripts, the digital transcription system also improves efficiency relative to conventional systems. In particular, the digital transcription system can reduce the amount of computational waste that conventional systems cause when generating digital transcripts and revising errors in digital transcripts. For instance, both processing resources and memory are preserved by generating accurate digital transcripts that require fewer user interactions and interfaces to review and revise. Further, the improved accuracy to digital transcripts reduces, and in many cases eliminates, the time and resources previously required for users to listen to and correct errors in the digital transcript.

Further, the digital transcription system provides increase flexibility over otherwise rigid conventional systems. More specifically, the digital transcription system can flexibly adapt to transcribe meetings corresponding to a wide scope of contexts while maintaining a high precision of accuracy. In contrast, conventional systems are limited to predefined vocabularies that commonly do not include (or flexibly emphasize) the subject matter discussed in particular meetings with particular participants. In addition, the digital transcription system can determine and utilize dynamic meeting context data that changes for particular participants, particular meetings, and particular times. For example, the digital transcription system can generate a first digital lexicon specific to a first set of meeting context data (e.g., a meeting with a participant and an accountant) and a second digital lexicon specific to second meeting context data (e.g., a meeting with the participant and an engineer).

As illustrated by the foregoing discussion, the present disclosure utilizes a variety of terms to describe features and advantages of the digital transcription system. Additional detail is now provided regarding these and other terms used herein. For example, as used herein, the term “meeting” refers to a gathering of users to discuss one or more subjects. In particular, the term “meeting” includes a verbal or oral discussion among users. A meeting can occur at a single location (e.g., a conference room) or across multiple locations (e.g., a teleconference or web-conference). In addition, while a meeting often includes verbal discussion among two or more speaking users, in some embodiments, a meeting includes one user speaking.

As mentioned, meetings include meeting participants. As used herein, the term “meeting participant” (or simply “participant”) refers to a user that attends a meeting. In particular, the term “meeting participant” includes users who speak at a meeting as well as users that attend a meeting without speaking. In some embodiments, a meeting participant includes users that are scheduled to attend or have accepted an invitation to attend a meeting (even if those users do not attend the meeting).

The term “audio data” (or simply “audio”) refers to an audio recording of at least a portion of a meeting. In particular, the term “audio data” includes captured audio or video of one or more meeting participants speaking at a meeting. Audio data can be captured by one or more computing devices, such as a client device, a telephone, a voice recorder, etc. In addition, audio data can be stored in a variety of formats.

Further, the term “meeting context data” refers to data or information associated with one or more meetings. In particular, the term “meeting context data” includes digital documents associated with a meeting participant, user features of a participant, and/or event details (e.g., location, time, etc.). In addition, meeting context data includes relational information between a user and digital documents, other users, projects, locations, etc., such as relational information indicated from a collaboration graph. Meeting context data can also include a meeting subject.

As used herein, the term “meeting subject” (or “subject”) refers to the theme, content, purpose, and/or topic of a meeting. In particular, the term “meeting subject” includes one or more topics, items, assignments, questions, concerns, areas, issues, projects, and/or matters discussed in a meeting. In many embodiments, a meeting subject relates to a primary focus of a meeting which meeting participants discuss. Additionally, meeting subjects can vary in scope from broad meeting subjects to narrow meeting subjects depending on the purpose of the meeting.

As used herein, the term “digital documents” refers to one or more electronic files. In particular, the term “digital documents” includes electronic files maintained by a digital content management system that stores and/or synchronizes files across multiple computing devices. In many embodiments, a user (e.g., meeting participant) is associated with one or more digital documents. For example, the user creates, edits, accesses, and/or manages one or more digital documents maintained by a digital content management system. For instance, the digital documents include metadata that tag the user with permissions to read, write, or otherwise access a digital document. A digital document can also include a previously generated digital lexicon corresponding to a meeting or user.

Additionally, the term “user features” refers to information describing a user or characteristics of a user. In particular, the term “user features” includes user profile information for a user. Examples of user features include a user's name, company name, company location, job position, job description, team assignments, project assignments, project descriptions, job history, awards, achievements, etc. Additional examples of user features can include other user profile information, such as biographical information, social information, and/or demographical information. In many embodiments, gathering and utilizing user features is subject to consent and approval (e.g., privacy settings) set by the user.

As mentioned above, the digital transcription system generates a digital transcript. As used herein, the term “digital transcript” refers to a written record of a meeting. In particular, the term “digital transcript” includes a written copy of words spoken at a meeting by one or more meeting participants. In various embodiments, a digital transcript is organized chronologically as well as divided by speaker. A digital transcript is often stored in a digital document, such as a in text file format that can be searched by keyword or searched phonetically.

In various embodiments, the digital transcription system creates and/or utilizes a digital lexicon to generate a digital transcript of a meeting. As used herein, the term “digital lexicon” refers to a specialized vocabulary (e.g., terms corresponding to a given subject, topic, or group). In particular, the term “digital lexicon” refers to a list of words that correspond to a meeting and/or participant. For instance, a digital lexicon includes original and uncommon words or jargon-specific language relating to a subject, topic, or matter being discussed at a meeting (or used by a participant or entity). A digital lexicon can also include acronyms and other abbreviations.

As mentioned above, the digital transcription system can utilize machine learning and various neural networks in various embodiments to generate a digital transcript. The term “machine learning,” as used herein, refers to the process of constructing and implementing algorithms that can learn from and make predictions on data. In general, machine learning may operate by building models from example inputs, such as audio data and/or meeting context data, to make data-driven predictions or decisions. Machine learning can include one or more machine-learning models and/or neural networks (e.g., a digital transcription model, a digital lexicon neural network, a digital transcription neural network, and/or a transcript redaction neural network).

As used herein, the term “neural network” refers to a machine learning model that can be tuned (e.g., trained) based on inputs to approximate unknown functions. In particular, the term neural network can include a model of interconnected neurons that communicate and learn to approximate complex functions and generate outputs based on a plurality of inputs provided to the model. For instance, the term neural network includes an algorithm (or set of algorithms) that implements deep learning techniques that utilize a set of algorithms to model high-level abstractions in data using supervisory data (e.g., transcription training data) to tune parameters of the neural network. For example, a neural network can include a convolutional neural network, a recurrent neural network (e.g., an LSTM), or an adversarial neural network (e.g., a generative adversarial neural network).

United States Provisional Application titled GENERATING CUSTOMIZED MEETING INSIGHTS BASED ON USER INTERACTIONS AND MEETING MEDIA, filed Jun. 24, 2019, and Unites States Provisional Application titled UTILIZING VOLUME-BASED SPEAKER ATTRIBUTION TO ASSOCIATE MEETING ATTENDEES WITH DIGITAL MEETING CONTENT, filed Jun. 24, 2019, are each hereby incorporated by reference in their entireties.

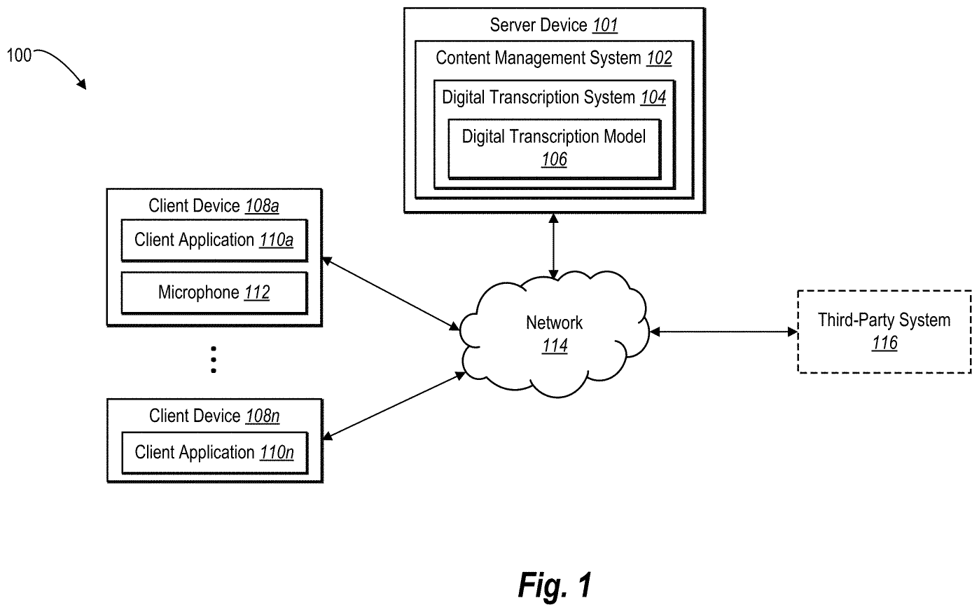

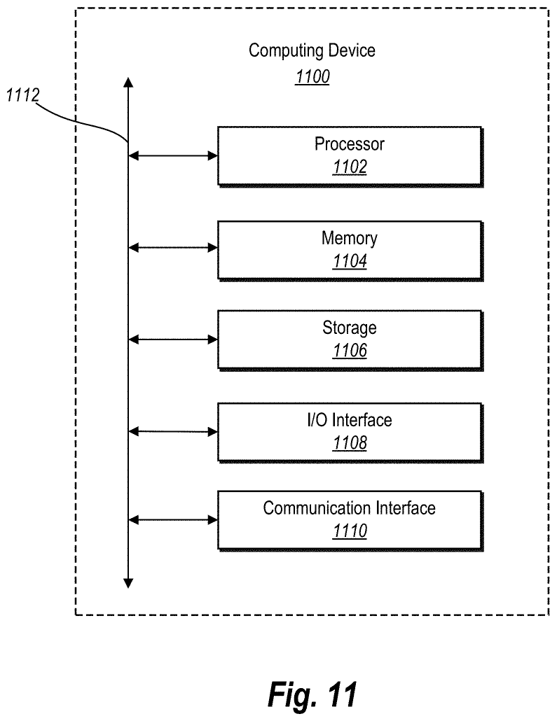

Additional detail will now be provided regarding the digital transcription system in relation to illustrative figures portraying example embodiments and implementations of the digital transcription system. To illustrate, FIG. 1 includes an embodiment of an environment 100, in which a digital transcription system 104 can operate. As shown, the environment 100 includes a server device 101 and client devices 108a-108n in communication via a network 114. Optionally, in one or more embodiments, the environment 100 also includes a third-party system 116. Additional description regarding the configuration and capabilities of the computing devices included in the environment 100 are provided below in connection with FIG. 11.

As illustrated, the server device 101 includes a content management system 102 that hosts the digital transcription system 104. Further, as shown, the digital transcription system includes a digital transcription model 106. In general, the content management system 102 manages digital data (e.g., digital documents or files) for a plurality of users. In many embodiments, the content management system 102 maintains a hierarchy of digital documents in a cloud-based environment (e.g., on the server device 101) and provides access to given digital documents for users on local client devices (e.g., the client device 108a-108n). Examples of content management systems include, but are not limited to, DROPBOX, GOOGLE DRIVE, and MICROSOFT ONEDRIVE.

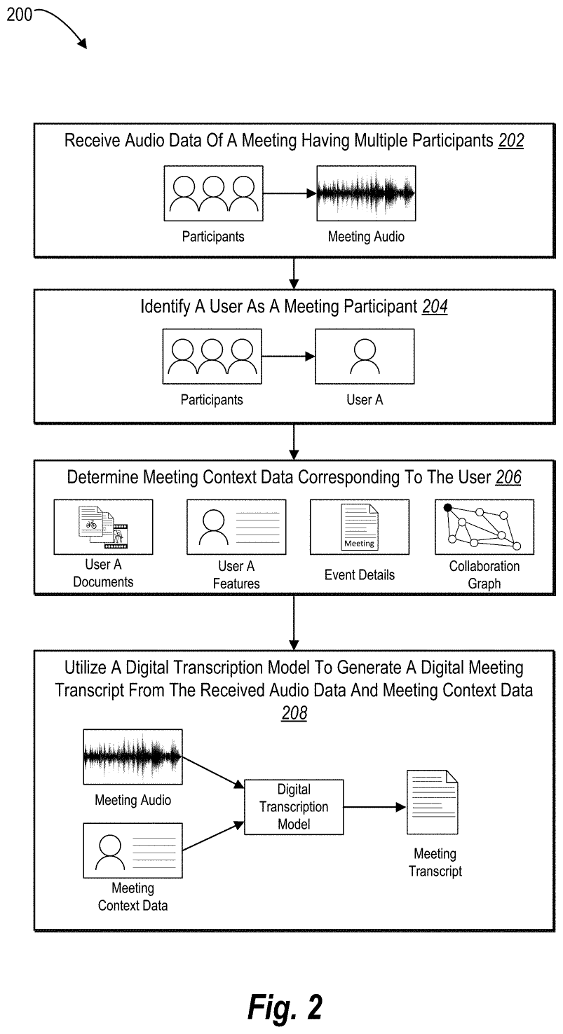

The digital transcription system 104 can generate digital transcripts from audio data of a meeting. In various embodiments, the digital transcription system 104 receives audio data from a client device, analyzes the audio data in connection with meeting context data utilizing the digital transcription model 106, and generates a digital transcript. Additional detail regarding the digital transcription system 104 generating digital transcripts utilizing the digital transcription model 106 is provided below with respect to FIGS. 2-10.

As mentioned above, the environment 100 includes client devices 108a-108n. Each of the client devices 108a-108n includes a corresponding client application 110a-110n. In various embodiments, a client application communicates audio data captured by a client device to the digital transcription system 104. For example, the client applications 110a-110n can include a meeting application, video conference application, audio application, or other application that allows the client devices 108a-108n to record audio/video as well as transmit the recorded media to the digital transcription system 104.

To illustrate, during a meeting, a meeting participant uses a first client device 108a to capture audio data of the meeting. For example, the first client device 108a (e.g., a conference telephone or smartphone) captures audio data utilizing a microphone 112 associated with the first client device 108a. In addition, the first client device 108a sends (e.g., in real time or after the meeting) the audio data to the digital transcription system 104. In additional embodiments, another client device (e.g., client device 108n) captures data related to user inputs detected during the meeting. For instance, a meeting participant utilizes a laptop client device to take notes during a meeting. In some embodiments, more than one client device provides audio data to the digital transcription system 104 and/or allows users to provide input during the meeting.

As shown, the environment 100 also includes an optional third-party system 116. In one or more embodiments, the third-party system 116 provides the digital transcription system 104 assistance in transcribing audio data into digital transcripts. For example, the digital transcription system 104 utilizes audio processing capabilities from the third-party system 116 to analyze audio data based on a digital lexicon generated by the digital transcription system 104. While shown as a separate system in FIG. 1, in various embodiments, the third-party system 116 is integrated within the digital transcription system 104.

Although the environment 100 of FIG. 1 is depicted as having a small number of components, the environment 100 may have additional or alternative components as well as alternative configurations. As one example, digital transcription system 104 can be implemented on or across multiple computing devices. As another example, the digital transcription system 104 may be implemented in whole by the server device 101 or the digital transcription system 104 may be implemented in whole by the first client device 108a. Alternatively, the digital transcription system 104 may be implemented across multiple devices or components (e.g., utilizing both the server device 101 and one or more client devices 108a-108n).

As mentioned above, the digital transcription system 104 can generate digital transcripts from audio data and meeting context data. In particular, FIG. 2 illustrates a series of acts 200 by which the digital transcription system 104 generates a digital meeting transcript. The digital transcription system 104 can be implemented by one or more computing devices, such as one or more server devices (e.g., server device 101), one or more client devices (e.g., client device 108a-108n), or a combination of server devices and client devices.

As shown in FIG. 2, the series of acts 200 includes the act 202 of receiving audio data of a meeting having multiple participants. For example, multiple users meet to discuss one or more topics and record the audio data of the meeting on a client device, such as a telephone, smartphone, laptop computer, or voice recorder. The digital transcription system 104 then receives the audio from the client device.

In addition, the series of acts 200 includes the act 204 of identifying a user as a meeting participant. In one or more embodiments, the digital transcription system 104 identifies one of the meeting participants in response to receiving audio data of the meeting. In alternative embodiments, the digital transcription system 104 identifies one or more meeting participants before the meeting occurs, for example, upon a user creating a meeting invitation or a calendar event for the meeting. In various embodiments, the digital transcription system 104 identifies one or more meeting participants based on digital documents and/or event details, as further described below.

Further, the series of acts 200 includes the act 206 of determining meeting context data. In particular, upon identifying a user as a meeting participant, the digital transcription system 104 can identify and access meeting context data associated with the user. For example, meeting context data can include digital documents and/or user features corresponding to a meeting participant. In addition, meeting context data can include event details and/or a collaboration graph.

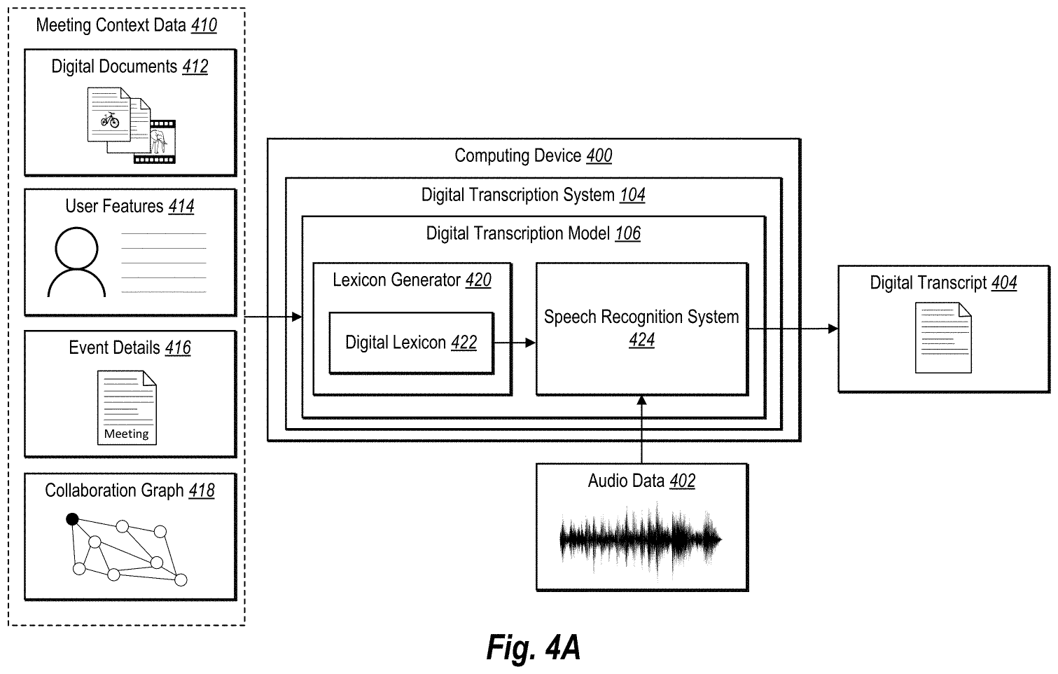

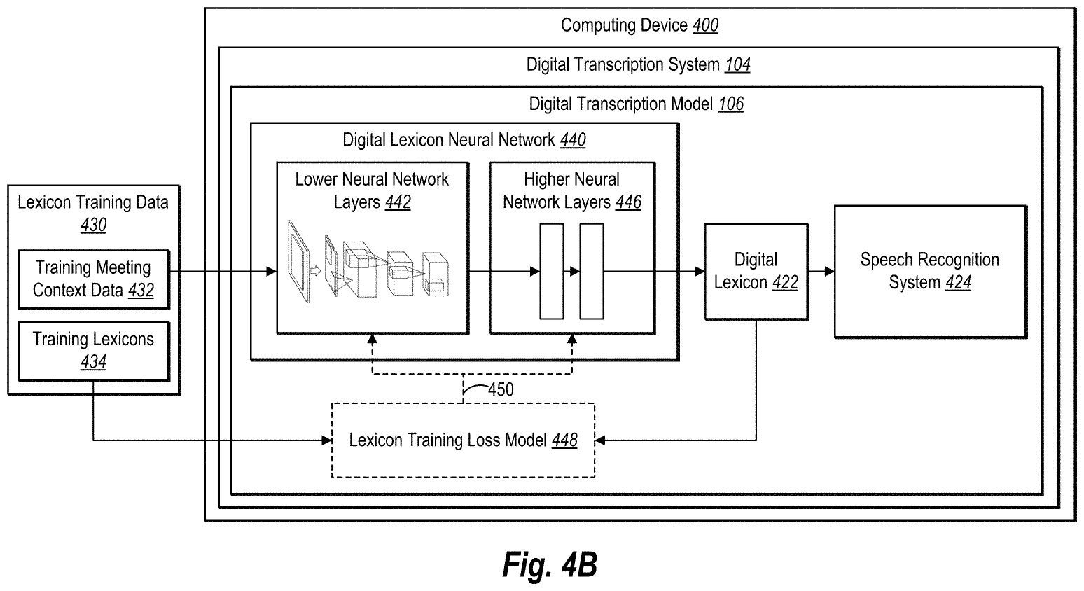

In one or more embodiments, the digital transcription system 104 accesses digital documents stored on a content management system associated with the user. In addition, the digital transcription system 104 can access user features of the user as well as event details (e.g., from a meeting agenda, digital event item, or meeting notes). In some embodiments, the digital transcription system 104 can also access a collaboration graph to determine where to obtain additional data relevant to the meeting. Additional detail regarding meeting context data is provided in connection with FIGS. 4A, 5A, 6, and 8.

As shown, the series of acts 200 also includes the act 208 of utilizing a digital transcription model to generate a digital meeting transcript from the received audio data and meeting context data. In one or more embodiments, the digital transcription system 104 generates and/or utilizes a digital transcription model (e.g., the digital transcription model 106) that generates a digital lexicon based on the meeting context data. The digital transcription system 104 then utilizes the digital lexicon to improve the word recognition accuracy of the digital meeting transcript. For example, the digital transcription system 104 utilizes the digital transcription model and the digital lexicon to accurately transcribe the audio. In another example, the digital transcription system 104 utilizes a third-party system to transcribe the audio utilizing the digital lexicon (e.g., third-party system 116).

In one or more embodiments, the digital transcription system 104 trains a digital lexicon neural network (i.e., a digital transcription model) to generate the digital lexicon for a meeting. For example, the digital transcription system 104 trains a neural network to receive meeting context data associated with a meeting or meeting participant and output a digital lexicon. Additional detail regarding utilizing a digital transcription model and/or a digital lexicon neural network to generate a digital lexicon is provided below in connection with FIGS. 4A-4B.

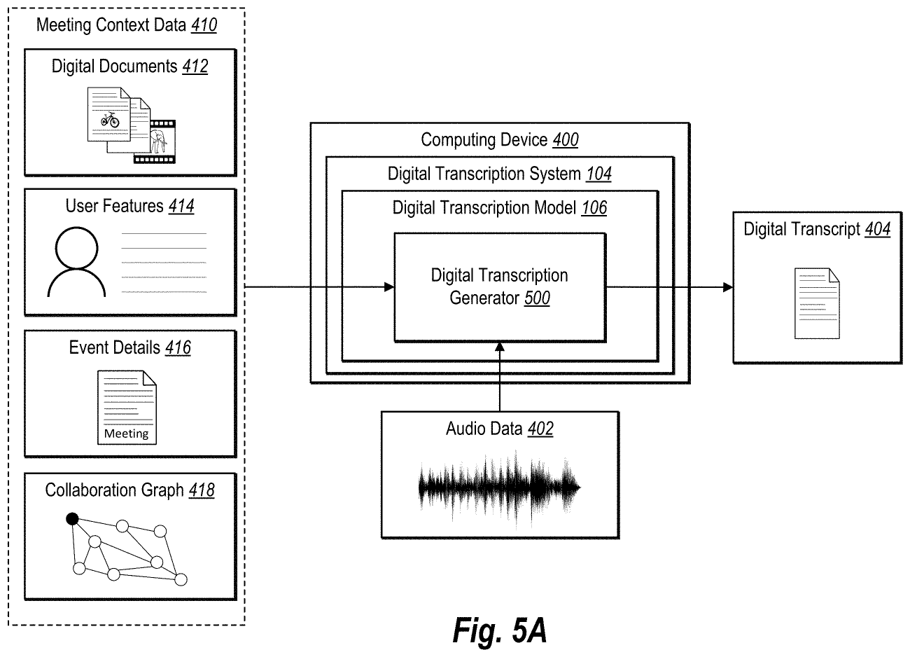

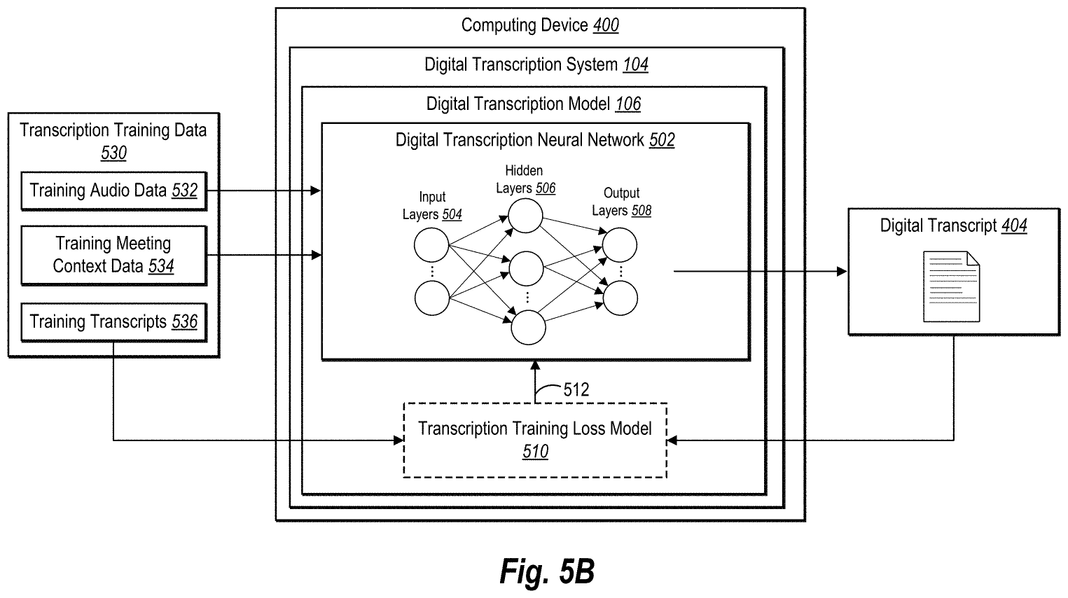

In some embodiments, the digital transcription system 104 creates and/or utilizes a digital transcription model that directly generates the digital meeting transcript from audio data and meeting context data. For example, the digital transcription system 104 utilizes meeting context data associated with a meeting or a meeting participant to generate a highly accurate digital meeting transcript along with audio data of the meeting. In one or more embodiments, the digital transcription system 104 trains a digital transcription neural network (i.e., a digital transcription model) to generate the digital meeting transcription from audio data and meeting context data. Additional detail regarding utilizing a digital transcription model and/or a digital transcription neural network to generate digital meeting transcripts is provided below in connection with FIGS. 5A-5B.

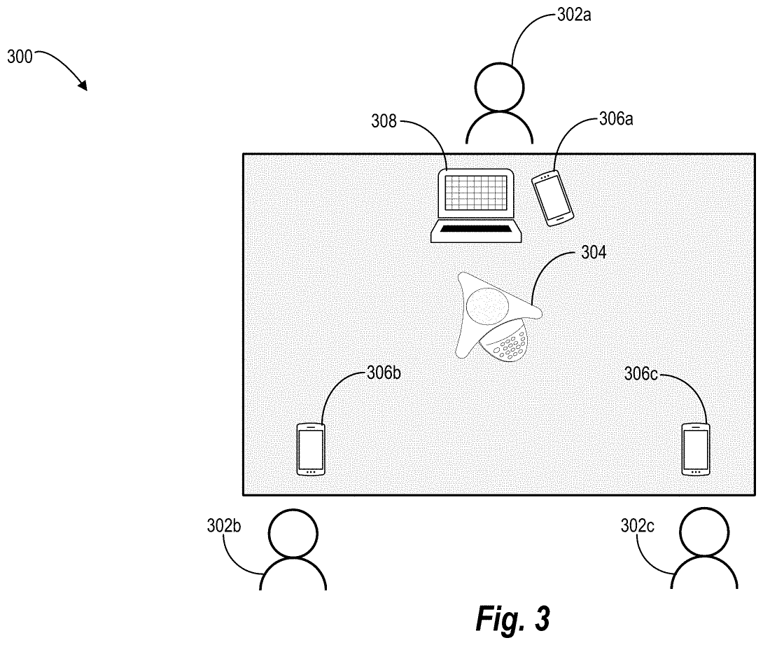

FIG. 3 illustrates a diagram of a meeting environment 300 involving multiple users in accordance with one or more embodiments. In particular, FIG. 3 shows a plurality of users 302a-302c involved in a meeting. During the meeting, each of the users 302a-302c can use one or more client devices during the meeting to record audio data and capture inputs (e.g., user inputs) via the client devices.

As shown, the meeting environment 300 includes multiple client devices. In particular, the meeting environment 300 includes a communication client device 304 associated with multiple users, such as a conference telephone device capable of connecting a call between the users 302a-302c and one or more remote users. The meeting environment 300 also includes handheld client devices 306a-306c associated with each of the users 302a-302c. Further, the meeting environment 300 also shows a portable client device 308 (e.g., laptop or tablet) associated with the first user 302a. Moreover, the meeting environment 300 can include additional client devices, such as a video client device that captures both audio and video (e.g., a webcam) and/or a playback client device (e.g., a television).

One or more of the client devices shown in the meeting environment 300 can capture audio data of the meeting. For instance, the third user 302c records the meeting audio using the third handheld client device 306c. In addition, one or more of the client devices can assist the users in participating in the meeting. For example, the second user 302b utilizes the second handheld client device 306b to view details associated with the meeting, access a meeting agenda, and/or take notes during the meeting.

Similarly, the users 302a-302c can use one or more of the client devices to run a client application that streams audio or video, sends and receives text communications (e.g., instant messaging and email), and/or shares information with other users (local and remote) during the meeting. For instance, the first user 302a provides supplemental materials or content to the other meeting participants during the meeting using the portable client device 308.

As shown in FIG. 3, a user can also be associated with more than one client device. For instance, the first user 302a is associated with the first handheld client device 306a and the portable client device 308. Further, the first user 302a is associated with communication the client device 304. Each client device can provide a different functionality to the first user 302a during a meeting. For example, the first user 302a utilizes the first handheld client device 306a to record the meeting or communicate with other meeting participants non-verbally. In addition, the first user 302a utilizes the portable client device 308 (e.g., laptop or tablet) to display information associated with the meeting (e.g., meeting agenda, slides, or other content) as well as take meeting notes.

In one or more embodiments, the digital transcription system 104 communicates with a client device (e.g., a client application on a client device) to obtain audio data and/or user input information associated with the meeting. For example, the second handheld client device 306b captures and provides audio to the digital transcription system 104 in real time or after the meeting. In another example, the third handheld client device 306c provides a copy of a meeting agenda to the digital transcription system 104 and/or provides notifications when the third user 302c interacted with the handheld client device 306c during the meeting. Also, as mentioned above, the portable client device 308 can provide, to the digital transcription system 104, metadata (e.g., timestamps) regarding the timing of each note with respect the meeting.

In some embodiments, a client device automatically records meeting audio data. For example, the communication client device 304 automatically records and temporarily stores meeting calls (e.g., locally or remotely). When the meeting ends, the digital transcription system 104 can prompt a meeting participant whether to keep and/or transcribe the recording. If the meeting participants requests a digital transcript of the meeting, in some embodiments, the digital transcription system 104 further prompts the user for meeting context data and/or regarding the sensitivity of the meeting. If the meeting is indicated as sensitive by the meeting participant (or automatically determined as sensitive by the digital transcription system 104, as described below), the digital transcription system 104 can locally transcribe the meeting. Otherwise, the digital transcription system 104 can generate a digital transcript of the meeting on a cloud computing device. In either case, the digital transcription system 104 can employ protective measures, such as encryption, to safeguard both the audio data and the digital transcript.

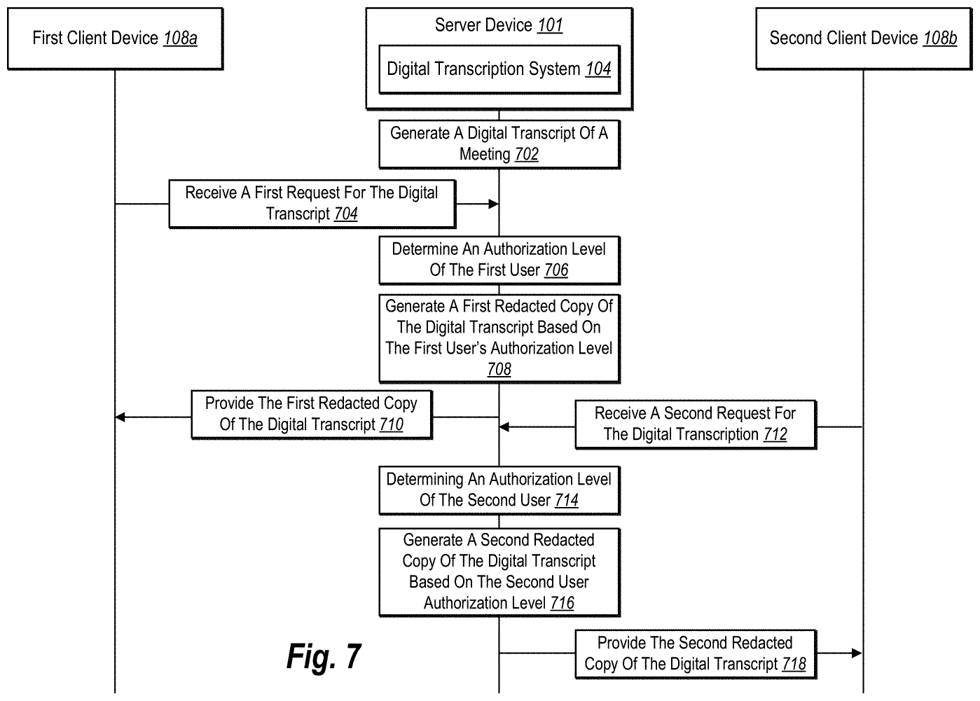

Similarly, the digital transcription system 104 can move, discard, or archive audio data and/or digital transcripts after a predetermined amount of time. For example, the digital transcription system 104 follows a document retention policy to process audio data that has not been accessed in over a year, for which a digital transcript exists. In some embodiments, the digital transcription system 104 redacts portions of the digital transcript (or audio data) after a predetermined amount of time. More information about redacting portions of a digital transcript is provided below in connection with FIG. 7.

As mentioned above, the digital transcription system 104 can receive audio data of the meeting from one or more client devices associated with meeting participants. For example, after the meeting, a client device that recorded audio data from the meeting synchronizes the audio data with the digital transcription system 104. In some embodiments, the digital transcription system 104 detects a user uploading audio from a meeting to the content management system 102 (e.g., by storing an audio data file in a folder that synchronizes with the content management system 102). In various embodiments, the audio is tagged with one or more timestamps, which the digital transcription system 104 can utilize to determine a correlation between a meeting, a meeting participant associated with the client device providing the audio.

Once the digital transcription system 104 obtains the audio data (and any device input data), the digital transcription system 104 can initiate the transcription process. As explained below in detail, the digital transcription system 104 can provide the audio data and meeting context data for at least one of the meeting participants to a digital transcription model, which generates a digital transcript of the meeting. Further, the digital transcription system 104 can provide a copy of the digital transcript to one or more meeting participants and/or store the digital transcript in a shared folder accessible by the meeting participants.

Turning now to FIGS. 4A-5B, additional detail is provided regarding the digital transcription system 104 creating and utilizing a digital transcription model to generate a digital transcript from audio data of a meeting. As mentioned above, the digital transcription system 104 can create, train, tune, execute, and/or update a digital transcription model to generate a highly accurate digital transcript of a meeting from audio data and meeting context data associated with a meeting participant. In some instances, the digital transcription model generates a digital lexicon based on meeting context data to improve the accuracy of the digital transcription of the meeting (e.g., FIGS. 4A-4B). In other instances, the digital transcription model directly generates a digital transcript based on audio data of a meeting and meeting context data associated with a meeting participant (e.g., FIGS. 5A-5B).

As shown, FIG. 4A includes a computing device 400 having the digital transcription system 104. In various embodiments, the computing device 400 can represent a server device as described above (i.e., the server device 101). In alternative embodiments, the computing device 400 represents a client device (e.g., the first client device 308a).

As also shown, the digital transcription system 104 includes the digital transcription model 106, which has a lexicon generator 420 and a speech recognition system 424. In addition, FIG. 4A includes audio data 402 of a meeting, meeting context data 410, and a digital transcript 404 of the meeting generated by the digital transcription model 106.

In one or more embodiments, the digital transcription system 104 receives the audio data 402 and utilizes the digital transcription model 106 to generate the digital transcript 404 based on the meeting context data 410. More specifically, the lexicon generator 420 within the digital transcription model 106 creates a digital lexicon 422 for the meeting based on the meeting context data 410 and the speech recognition system 424 generates the digital transcript 404 based on the audio data 402 of the meeting and the digital lexicon 422.

As mentioned above, the lexicon generator 420 generates a digital lexicon 422 for a meeting based on the meeting context data 410. The lexicon generator 420 can create the digital lexicon 422 heuristically or utilizing a trained machine-learning model, as described further below. Before describing how the lexicon generator 420 generates a digital lexicon 422, additional detail is first provided regarding identifying a user as a meeting participant as well as the meeting context data 410.

In various embodiments, when a user requests a digital transcript of audio data of a meeting, the digital transcription system 104 prompts the user for meeting participants and/or event details. For example, the digital transcription system 104 prompts the user whether they attended the meeting and/or other users that attended the meeting. In some embodiments, the digital transcription system 104 prompts the user via a client application on the user's client device (e.g., client application 110a), which also facilitates uploading the audio data 402 of the meeting to the digital transcription system 104.

In alternative embodiments, the digital transcription system 104 can automatically identify meeting participants and/or event details upon receiving the audio data 402. In one or more embodiments, the digital transcription system 104 identifies the user that created and/or submitted the audio data 402 to the digital transcription system 104. For example, the digital transcription system 104 looks up the client device that captured the audio data 402 and determines which user is associated with the client device. In another example, the digital transcription system 104 identifies a user identifier from the audio data 402 corresponding to the user that created and/or provided the audio data 402 to the digital transcription system 104. In a further example, the user captures the audio data 402 within a client application on a client device where the that the user is logged in to the client application.

In various embodiments, the digital transcription system 104 can determine the meeting and/or a meeting participant based on correlating meetings and/or user data to the audio data 402. For example, in one or more embodiments, the digital transcription system 104 accesses a lists of meetings and correlates timestamp information from the audio data 402 to determine the given meeting from the list of meetings and, in some cases, meeting participants. In other embodiments, the digital transcription system 104 accesses digital calendar items of users within an organization or company and correlates a scheduled meeting time with the audio data 402.

In additional and/or alternative embodiments, the digital transcription system 104 identifies location data from the audio data 402 indicating where the audio data 402 was created and correlates the location of meetings (e.g., indicated in digital calendar items) and/or users (e.g., indicated from a user's client device). In various embodiments, the digital transcription model 106 utilizes speech recognition to identify a participant's voice from the audio data 402 to determine that the user was a meeting participant.

Upon identifying one or more users as a meeting participant that correspond to the audio data 402, the digital transcription system 104 can determine meeting context data 410 associated with the one or more meeting participants. In one or more embodiments, the digital transcription system 104 determines the meeting context data 410 associated with a meeting participant upon receiving the audio data 402 of a meeting. In alternative embodiments, the digital transcription system 104 accesses the meeting context data 410 associated with a user prior to a meeting.

As shown, the meeting context data 410 includes digital documents 412, user features 414, event details 416, and a collaboration graph 418. In one or more embodiments, the digital documents 412 associated with a user include all of the documents in an organization (i.e., an entity) that are accessible (and/or authored/co-authored) by the user. For instance, the documents for an organization are maintained on a content management system. The user may have access to a subset or portion of those documents. For example, the user has access to documents associated with a first project but not documents associated with a second project. In one or more embodiments, the content management system utilizes metadata tags or other labels to indicate which of the documents within the organization are accessible by the user.

The digital documents 412 associated with a user can include other documents associated with the user. For example, the digital documents 412 include documents collaborated upon between sets of multiple users, of which the user is a co-author, a collaborator, or a participant. In various embodiments, the digital documents 412 can include electronic messages (e.g., emails, instant messages, text messages, etc.) of the user and/or media attachments included in electronic messages. In addition, in some embodiments, the digital documents 412 can include web links or files associated with a user (e.g., a user's browser history).

In various embodiments, upon accessing the digital documents 412 associated with a user, the digital transcription system 104 can filter the digital documents 412 based on meeting relevance. For instance, in one or more embodiments, the digital transcription system 104 identifies digital documents 412 of the user that are associated with the meeting. For example, the digital transcription system 104 identifies the digital documents 412 of the user that correspond to the event details 416. In some embodiments, the digital transcription system 104 filters digital documents based on recency, folder location, labels, tags, keywords, user associations, etc. In addition, the digital transcription system 104 can identify/filter digital documents based on a meeting participant authoring, editing, sharing, or viewing a digital document.

As shown, the meeting context data 410 includes user features 414. In various embodiments, the user features 414 associated with a user include user profile information, company information, user accounts, and/or client devices. For example, the user features 414 of a user include user profile information such as the user's name, biographical information, social information, and/or demographical information. In addition, the user features 414 of a user include company information (i.e., entity information) of the user such as the user's company name, company location, job title, job position within the company, job description, team assignments, project assignments, project descriptions, job history.

Further, the user features 414 of a user can include accounts and affiliations of the user as well as a record of client devices associated with the user. For example, the user may be a member of an engineering society or a sales network. As another example, the user may have accounts with one or more services or applications. Additionally, the user may be associated with personal client devices, work client devices, handheld client devices, etc. In some embodiments, the digital transcription system 104 utilizes these user features 414 to identify additional digital documents 412 associated with the user and/or to detect additional user features 414.

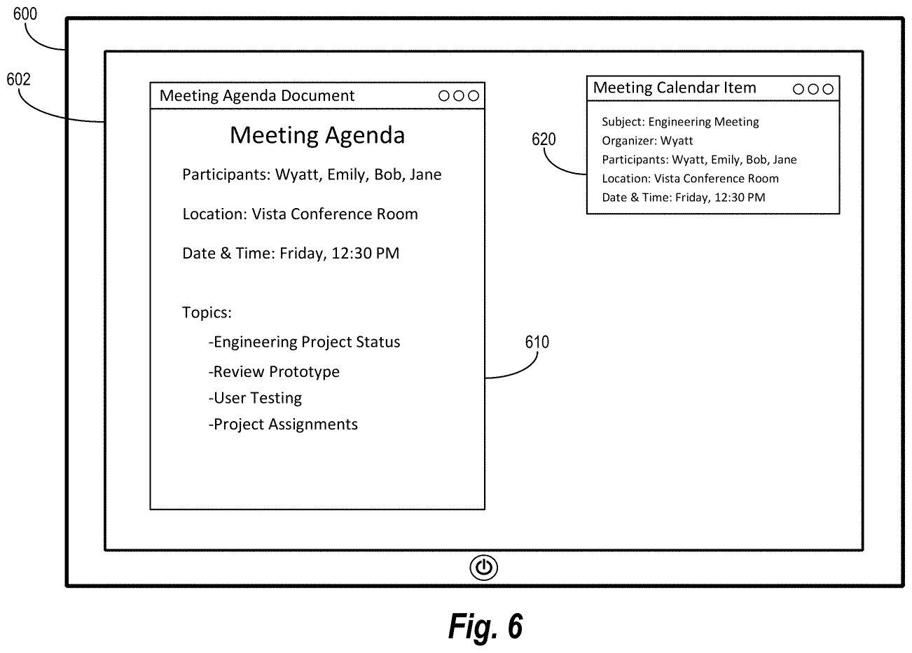

In addition, the meeting context data 410 includes event details 416. In one or more embodiments, the event details 416 includes locations, time, duration, and/or subject. The digital transcription system 104 can identify event details 416 from a digital event item (e.g., a calendar event), meeting agendas, participant lists, and/or meeting notes. To illustrate, a meeting agenda can indicate relevant context and information about a meeting such as a meeting occurrence (e.g., meeting date, location, and time), a participant list, and meeting items (e.g., discussion items, action items, and assignments). An example of a meeting agenda is provided below in connection with FIG. 6.

In addition, a meeting participant list can indicate users that were invited, accepted, attended, missed, arrived late, left, early, etc., as well as how users attended the meeting (e.g., in person, call in, video conference, etc.) Further, meeting notes can include notes provided by one or more users at the meeting, timestamp information associated with when one or more notes at the meeting were recorded, whether multiple users recorded similar notes, etc.

Further, in some embodiments, the event details 416 includes calendar events (e.g., meeting event items) of a meeting, such as a digital meeting invitation. Often, a calendar event indicates relevant context and information about a meeting such as meeting title or subject, date and time, location, participants, agenda items, etc. In some cases, the information in the calendar event overlaps with the meeting agenda information. An example of a calendar event for a meeting is provided below in connection with FIG. 6.

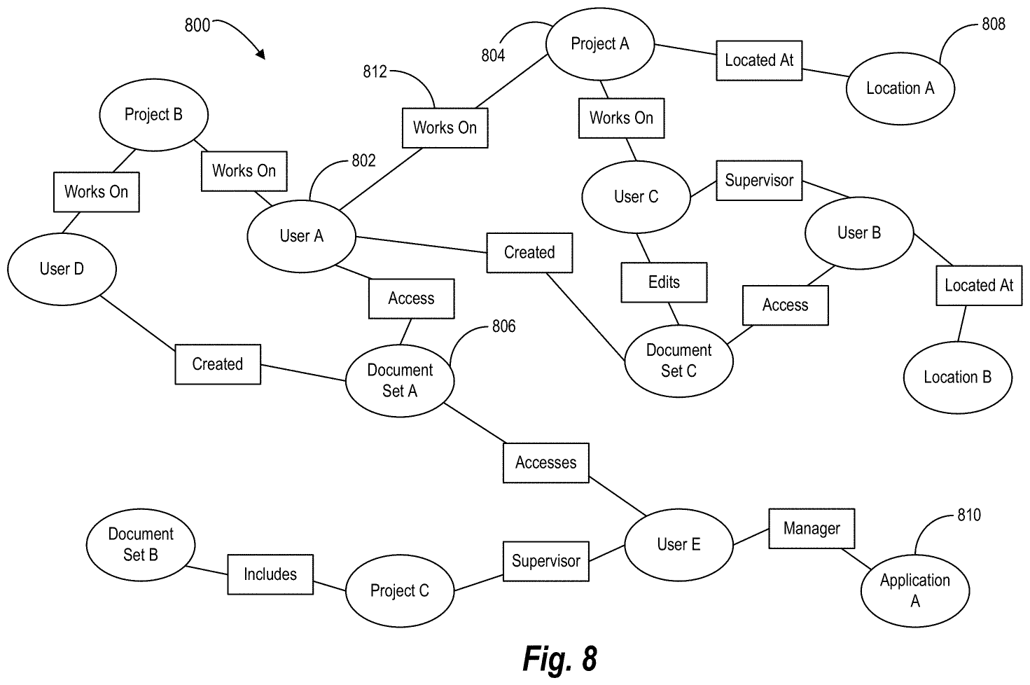

As shown, the meeting context data 410 includes the collaboration graph 418. In general, the collaboration graph 418 provides relationships between users, projects, interests, organizations, documents, etc. Additional description of the collaboration graph 418 is provided below in connection with FIG. 8.

As mentioned above, the digital transcription system 104 utilizes the lexicon generator 420 within the digital transcription model 106 to create a digital lexicon 422 for a meeting, where the digital lexicon 422 is generated based on the meeting context data 410 of a meeting participant. More particularly, in various embodiments, the lexicon generator 420 receives the meeting context data 410 associated with a meeting participant. For instance, the lexicon generator 420 receives digital documents 412, user features 414, event details 416, and/or a collaboration graph 418 associated with the meeting participant. Utilizing the content of the meeting context data 410, the lexicon generator 420 creates the digital lexicon 422 associated with the meeting.

In various embodiments, the digital transcription system 104 first filters the content of the meeting context data 410 before generating a digital lexicon. For example, the digital transcription system 104 filters the meeting context data 410 based on recency (e.g., within 1 week, 30 days, 1 year, etc.), relevance to event details, location within a content management system (e.g., within a project folder), access rights of other users, and/or other associations to the meeting. For instance, the digital transcription system 104 compares the content of the event details 416 to the content of the digital documents 412 to determine which of the digital documents are most relevant or are above a threshold relevance level. In alternative embodiments, the digital transcription system 104 utilizes all of the meeting context data 410 to create a digital lexicon for the user.

As mentioned above, the lexicon generator 420 can create the digital lexicon 422 heuristically or utilizing a trained neural network. For instance, in one or more embodiments, the lexicon generator 420 utilizes a heuristic function to analyze the content of the meeting context data 410 to generate the digital lexicon 422. To illustrate, the lexicon generator 420 generates a frequency distribution of words and phrases from digital documents 412. In some embodiments, after removing common words and phrases (e.g., a, and, the, from, etc.), the lexicon generator 420 identifies the words that appear most frequently and adds those words to the digital lexicon 422. In one or more embodiments, the lexicon generator 420 weights the words and phrases in the frequency distribution based on words and phrases that appear in the event details 416 and the user features 414.

In some embodiments, the lexicon generator 420 adds weight to words and phrases in the frequency distribution that have a higher usage frequency in the digital documents 412 than in everyday usage (e.g., compared to a public document corpus or all of the documents associated with the user's company). Then, based on the weighted frequencies, the lexicon generator 420 can determine which words and phrases to include in the digital lexicon 422.

Just as the lexicon generator 420 can utilize content in the digital documents 412 of a meeting participant to create the digital lexicon 422, the lexicon generator 420 can similarly create a digital lexicon from the user features 414, the event details 416, and/or the collaboration graph 418. For example, the lexicon generator 420 includes words and phrases from the event details 416 in the digital lexicon 422, often given those words and phrases greater weight because of their direct relevance to the context of the meeting. Additionally, the lexicon generator 420 can parse and extract words and phrases from the user features 414, such as a project description, to include in the digital lexicon 422.

As an example of generating a digital lexicon 422 based on event details 416, in one or more embodiments, the digital transcription system 104 can utilize user notes taken during or after the meeting (e.g., a meeting summary) to generate at least a part of the digital lexicon 422. For example, the lexicon generator 420 prioritizes words and phrases captured during the meeting when generated the digital lexicon 422. For instance, a word or phrase captured near the beginning of the meeting from notes can be added to the digital lexicon 422 (as well as used to improve real-time transcription later in the same meeting when the word or phrase again used). Likewise, the lexicon generator 420 can give further weight to words recorded by multiple meeting participants.

In one or more embodiments, the lexicon generator 420 employs the collaboration graph 418 to create the digital lexicon 422. For example, the lexicon generator 420 locates the meeting participant on the collaboration graph 418 for an entity (e.g., an organization or company) and determines which digital documents, projects, co-users, etc. are most relevant to the meeting. Additional description regarding a collaboration graph is provided below in connection with FIG. 8.

In some embodiments, the lexicon generator 420 is a trained digital lexicon neural network that creates the digital lexicon 422 from the meeting context data 410. In this manner, the digital transcription system 104 provides the meeting context data 410 for one or more users to the trained digital lexicon neural network, which outputs the digital lexicon 422. FIG. 4B below provides additional description regarding training a digital lexicon neural network.

As described above, in one or more embodiments, the digital transcription system 104 provides the meeting context data 410 to the digital transcription model 106 to generate the digital lexicon 422 via the lexicon generator 420. In alternative embodiments, upon receiving the audio data 402 of a meeting and identifying a meeting participant, the digital transcription system 104 accesses a digital lexicon 422 previously created for the meeting participant and/or other users that participated in the meeting.

As shown in FIG. 4A, the digital transcription system 104 provides the digital lexicon 422 to the speech recognition system 424. Upon receiving the digital lexicon 422 and the audio data 402, the speech recognition system 424 can transcribe the audio data 402. In particular, the speech recognition system 424 can increase the weight of potential words included in the digital lexicon 422 than other words when detecting and recognizing speech from the audio data 402 of the meeting.

To illustrate, the speech recognition system 424 determines that a sound in the audio data 402 has a 60% probability (e.g., prediction confidence level) of being “metal” and a 75% probability of being “medal.” Based on identifying the word “metal” in the meeting context data 410, the lexicon generator 420 can increase the probability of the word “metal” (e.g., add 20% or weight the probability by a factor of 1.5, etc.). In some embodiments, each of the words in the digital lexicon 422 have an associated weight that is to be applied to the prediction score for corresponding recognized words (e.g., based on their relevant to a meeting's context).

In one or more embodiments, such as the illustrated embodiment, the speech recognition system 424 is implemented as part of the digital transcription model 106. In some embodiments, the speech recognition system 424 is implemented outside of the digital transcription model 106 but within the digital transcription system 104. In alternative embodiments, the speech recognition system 424 is located outside of the digital transcription system 104, such as being hosted by a third-party service. In each case, the digital transcription system 104 provides the audio data 402 and the digital lexicon 422 to the speech recognition system 424, which generates the digital transcript 404.

In various embodiments, the digital transcription system 104 employs an ensemble approach to improved accuracy of a digital transcript of a meeting. To illustrate, in some embodiments, the digital transcription system 104 provides the audio data 402 and the digital lexicon 422 to multiple speech recognition systems (e.g., two native systems, two third-party systems, or a combination of native and third-party systems), which each generate a digital transcript. The digital transcription system 104 then compares and combines the digital transcripts into the digital transcript 404.

Further, in some embodiments, to further improve transcription accuracy, the digital transcription system 104 can pre-process the audio data 402 before utilizing it to generate the digital transcript 404. For example, the digital transcription system 104 applies noise reduction, adjusts gain controls, increases or decreases the speed, applies low-pass and/or high-pass filters, normalizes volumes, adjusts sampling rates, applies transformations, etc., to the audio data 402.

As mentioned above, the digital transcription system 104 can create and store a digital lexicon for a user. To illustrate, the digital transcription system 104 utilizes the same digital lexicon for multiple meetings. For example, in the case of a reoccurring weekly meeting on the same subject with the same participants, the digital transcription system 104 can utilize a previously generated digital lexicon 422. Further, the digital transcription system 104 can update the digital lexicon 422 offline as new meeting context data is provided to the content management system rather than in response to receiving new audio data of the reoccurring meeting.

As another illustration, the digital transcription system 104 can create and utilize a digital lexicon on a per-user basis. In this manner, the digital transcription system 104 utilizes a previously created digital lexicon for a user rather than recreate a digital lexicon each time audio data for a meeting is received where the user is a meeting participant. Additionally, the digital transcription system 104 can create multiple digital lexicons for a user based on different meeting contexts (e.g., a first subject and a second subject). For example, if a user participates in sales meetings as well as engineering meetings, the digital transcription system 104 can create and store a sales digital lexicon and an engineering digital lexicon for the user. Then, upon detecting a context of a meeting as a sales or an engineering meeting, the digital transcription system 104 can select the corresponding digital lexicon. In some embodiments, the digital transcription system 104 detects that a meeting subject changes part-way through transcribing the audio data 402 and changes the digital lexicon is being used to influence speech transcription predictions.

Similarly, in various embodiments, the digital transcription system 104 can create, store, and utilize multiple digital lexicons that correspond to various meeting contexts (e.g., different subjects or other contextual changes). For example, the digital transcription system 104 creates a project-based digital lexicon based on the meeting context data of users assigned to the project. In another example, the digital transcription system 104 detect a repeat meeting between users and generates a digital lexicon for further instances of the meeting. In some embodiments, the digital transcription system 104 creates a default digital lexicon corresponding to company, team, or group of users to utilizes when a meeting participant or meeting participants are not associated with an adequate amount of meeting context data to generate a digital lexicon.

As mentioned above, FIG. 4B describes training a digital lexicon neural network. In particular, FIG. 4B illustrates a block diagram of training a digital lexicon neural network 440 that generates the digital lexicon 422 in accordance with one or more embodiments. As shown, FIG. 4B includes the computing device 400 from FIG. 4A. Notably, the lexicon generator 420 in FIG. 4A is replaced with the digital lexicon neural network 440 and an optional lexicon training loss model 448. Additionally, FIG. 4B includes lexicon training data 430.

As shown, the digital lexicon neural network 440 is a convolutional neural network (CNN) that includes lower neural network layers 442 and higher neural network layers 446. For instance, the lower neural network layers 442 (e.g., convolutional layers) generate lexicon feature vectors from meeting context data that the higher neural network layers 446 (e.g., classification layers) transform the feature vectors into the digital lexicon 422. In one or more embodiments, the digital lexicon neural network 440 is an alternative type of neural network, such as a recurrent neural network (RNN), a residual neural network (ResNet) with or without skip connections, or a long- short-term memory (LSTM) neural network. Further, in alternative embodiments, the digital transcription system 104 utilizes other types of neural networks to generate a digital lexicon 422 from the meeting context data 410.

In one or more embodiments, the digital transcription system 104 trains the digital lexicon neural network 440 utilizing the lexicon training data 430. As shown, the lexicon training data 430 includes training meeting context data 432 and training lexicons 434. To train the digital lexicon neural network 440, the digital transcription system 104 feeds the training meeting context data 432 to the digital lexicon neural network 440, which generates a digital lexicon 422.

Further, the digital transcription system 104 provides the digital lexicon 422 to the lexicon training loss model 448, which compares the digital lexicon 422 to a corresponding training lexicon 434 (e.g., a ground truth) to determine a lexicon error amount 450. The digital transcription system 104 then back propagates the lexicon error amount 450 to the digital lexicon neural network 440. More specifically, the digital transcription system 104 provides the lexicon error amount 450 to the lower neural network layers 442 and the higher neural network layers 446 to tune and fine-tune the weights and parameters of these layers to generate a more accurate digital lexicon. The digital transcription system 104 can train the digital lexicon neural network 440 in batches until the network converges or until the lexicon error amount 450 drops below a threshold.

In some embodiments, the digital transcription system 104 continues to train the digital lexicon neural network 440. For example, in response to generating a digital lexicon 422, a user can return an edited or updated version of the digital lexicon 422. The digital lexicon neural network 440 can then use the updated version to further fine-tune and improve the digital lexicon neural network 440.

As described above, in various embodiments, the digital transcription system 104 utilizes a digital transcription model 106 to create a digital lexicon from meeting context data, which in turn is used to generate a digital transcript of a meeting having improved accuracy over conventional systems. In alternative embodiments, the digital transcription system 104 utilizes a digital transcription model 106 to generate a digital transcript of a meeting directly from meeting context data, as described in FIGS. 5A-5B.

To illustrate, FIG. 5A illustrates a block diagram of utilizing a digital transcription model to generate a digital transcript from audio data and meeting context data in accordance with one or more embodiments. As shown, the computing device includes the digital transcription system 104, the digital transcription model 106, and a digital transcription generator 500. As with FIG. 4A, the digital transcription system 104 receives audio data 402 of a meeting, determines the meeting context data 410 in relation to users that participated in the meeting, and generates a digital transcript 404 of the meeting.

More specifically, the digital transcription generator 500 within the digital transcription model 106 generates the digital transcript 404 based on the audio data 402 of the meeting and the meeting context data 410 of a meeting participant. In one or more embodiments, the digital transcription generator 500 heuristically generates the digital transcript 404. In alternative embodiments, the digital transcription generator 500 is a neural network that generates the digital transcript 404.

As just mentioned, in one or more embodiments, the digital transcription generator 500 within the digital transcription model 106 utilizes a heuristic function to generate the digital transcript 404. For example, the digital transcription generator 500 forms a set of rules and/or procedures with respect to the meeting context data 410 that increases the speech recognition accuracy and prediction of the audio data 402 when generating the digital transcript 404. In another example, the digital transcription generator 500 applies words, phrases, and content, of the meeting context data 410 to increase accuracy when generating a digital transcript 404 of the meeting from the audio data.

In some embodiments, the digital transcription generator 500 applies heuristics such as number of meeting attendees, job positions, meeting location, remote user locations, time of day, etc. to improve prediction accuracy of recognized speech in the audio data 402 of a meeting. For example, upon determining that a sound in the audio data 402 could be “lunch” or “launch,” the digital transcription generator 500 weights “lunch” with a higher probability than “launch” if the meeting is around lunchtime (e.g., noon).

In various embodiments, the digital transcription system 104 improves generation of the digital transcript using a contextual weighting heuristic. For instance, the digital transcription system 104 determines the context or subject of a meeting from the audio data 402 and/or meeting context data 410. Next, when recognizing speech from the audio data 402, the digital transcription system 104 weights predicted words for sounds that correspond to the identified meeting subject. Moreover, the digital transcription system 104 applies diminishing weights to predicted words of a sound based on how far removed the word is from the meeting subject. In this manner, when the digital transcription system 104 is determining between multiple possible words for a recognized sound in the audio data 402, the digital transcription system 104 is influenced to select the word that shares the greatest affinity to the identified meeting subject (or other meeting context).

In one or more embodiments, the digital transcription system 104 can utilize user notes (e.g., as event details 416) taken during the meeting as a heuristic to generate a digital transcript 404 of a meeting. For instance, the digital transcription system 104 identifies a timestamp corresponding to notes recorded during the meeting by one or more meeting participants. In response, the digital transcription system 104 identifies the portion of the audio data 402 at or before the timestamp and weights the detected speech that corresponds to the notes. In some instances, the weight is increased if multiple meeting participants recorded similar notes around the same time in the meeting.

In additional embodiments, the digital transcription system 104 can receive both meeting notes and the audio data 402 in real time. Further, the digital transcription system 104 can detect a word or phrase in the notes early in the meeting, then accurately transcribe the word or phrase in the digital transcript 404 each time the word or phrase is detected later in the meeting. In cases where the meeting has little to no meeting context data, this approach can be particularly beneficial in improving the accuracy of the digital transcript 404.

As mentioned above, the digital transcription system 104 can utilize initial information about a meeting to retrieve the most relevant meeting context data. In some embodiments, the digital transcription system 104 can generate an initial digital transcript of all or a portion of the audio data before accessing the meeting context data 410. The digital transcription system 104 then analyzes the first digital transcript to retrieve relevant content (e.g., relevant digital documents). Alternatively, as described above, the digital transcription system 104 can determine the subject of a meeting from analyzing event details or by user input and then utilize the identified subject to gather additional meeting context data (e.g., relevant documents or information from a collaboration graph related to the subject).

In alternative embodiments to employing a heuristic function, the digital transcription generator 500 within the digital transcription model 106 utilizes a digital transcription neural network to generate the digital transcript 404. For instance, the digital transcription system 104 provides the audio data 402 of the meeting and the meeting context data 410 of a meeting participant to the digital transcription generator 500, which is trained to correlate content from the meeting context data 410 with speech from the audio data 402 and generate a highly accurate digital transcript 404. Embodiments of training a digital transcription neural network are described below with respect to FIG. 5B.

Irrespective of the type of digital transcription model 106 that the digital transcription system 104 employs to generate a digital transcript, the digital transcription system 104 can utilize additional approaches and techniques to further improve accuracy of the digital transcript. To illustrate, in one or more embodiments, the digital transcription system 104 receives multiple copies of the audio data of a meeting recorded at different client devices. For example, multiple meeting participants record and provide audio data of the meeting. In these embodiments, the digital transcription system 104 can utilize one or more ensemble approaches to generate a highly accurate digital transcript.

In some embodiments, the digital transcription system 104 combines audio data from the multiple recordings before generating a digital transcript. For example, the digital transcription system 104 analyzes the sound quality of corresponding segments from the multiple recordings and selects the recording that provides the highest quality sound for a given segment (e.g., the recording device closer to the speaker will often capture a higher-quality recording of the speaker).

In alternative embodiments, the digital transcription system 104 transcribes each recording separately and then merges and compares the two digital transcripts. For example, when two different meeting participants each provide audio data (e.g., recordings) of a meeting, the digital transcription system 104 can access different meeting context data associated with each user. In some embodiments, the digital transcription system 104 uses the same meeting context data for both recordings but utilizes different weightings for each recording based on the which portions of the meeting context data are more closely associated with the user submitting the particular recording. Upon comparing the separate digital transcripts, when a conflict between words in the two digital transcripts occur, in some embodiments, the digital transcription system 104 can select the word with a higher prediction confidence level and/or the recording having better sound quality for the word.

In one or more embodiments, the digital transcription system 104 can utilize the same audio data with different embodiments of the digital transcription model 106 and/or subcomponents of the digital transcription model 106, then combine the resulting digital transcripts to improve the accuracy of the digital transcript. To illustrate, in some embodiments, the digital transcription system 104 utilizes a first digital transcription model that generates a digital transcript upon creating a digital lexicon and a second digital transcription model that generates a digital transcript utilizing a trained digital transcription neural network. Other combinations and embodiments of the digital transcription model 106 are possible as well.

As mentioned above, the digital transcription system 104 can train the digital transcription generator 500 as a digital transcription neural network. To illustrate, FIG. 5B shows a block diagram of training a digital transcription neural network to generate a digital transcript in accordance with one or more embodiments. As shown, FIG. 5B includes the computing device 400 having the digital transcription system 104, where the digital transcription system 104 further includes the digital transcription model 106 having the digital transcription neural network 502 and a transcription training loss model 510. In addition, FIG. 5B shows transcription training data 530.

As also shown, the digital transcription neural network 502 is illustrated as a recurrent neural network (RNN) that includes input layers 504, hidden layers 506, and output layers 508. While a simplified version of a recurrent neural network is shown, the digital transcription system 104 can utilize a more complex neural network. As an example, the recurrent neural network can include multiple hidden layer sets. In another example, the recurrent neural network can include additional layers, such as embedding layers, dense layers, and/or attention layers.

In some embodiments, the digital transcription neural network 502 comprises a specialized type of recurrent neural network, such as a long- short-term memory (LSTM) neural network. To illustrate, in some embodiments, a long short-term memory neural network includes a cell having an input gate, an output gate, and a forget gate as well as a cell input. In addition, a cell can remember previous states and values (e.g., words and phrases) over time (including hidden states and values) and the gates control the amount of information that is input and output from a cell. In this manner, the digital transcription neural network 502 can learn to recognize sequences of words that correspond to phrases or sentences used in a meeting.

In alternative embodiments, the digital transcription system 104 utilizes other types of neural networks to generate a digital transcript 404 from the meeting context data and the audio data. For example, in some embodiments, the digital transcription neural network 502 is a convolutional neural network (CNN) or a residual neural network (ResNet) with or without skip connections.

In one or more embodiments, the digital transcription system 104 trains the digital transcription neural network 502 utilizing the transcription training data 530. As shown, the transcription training data 530 includes training audio data 532, training meeting context data 534, and training transcripts 536. For example, the training transcripts 536 correspond to the training audio data 532 in the transcription training data 530 such that the training transcripts 536 serve as a ground truth for the training audio data 532.

To train the digital transcription neural network 502, in one or more embodiments, the digital transcription system 104 provides the training audio data 532 and the training meeting context data 534 (e.g., vectorized versions of the training data) to the input layers 504. The input layers 504 encode the training data and provide the encoded training data to the hidden layers 506. Further, the hidden layers 506 modify the encoded training data before providing it to the output layers 508. In some embodiments, the output layers 508 include classifying and/or decoding the modified encoded training data. Based on the training data, the digital transcription neural network 502 generates a digital transcript 404, which the digital transcription system 104 provides to the transcription training loss model 510. In addition, the digital transcription system 104 provides the training transcripts 536 from the transcription training data 530 to the transcription training loss model 510.

In various embodiments, the transcription training loss model 510 utilizes the training transcripts 536 for meetings as a ground truth to verify the accuracy of digital transcripts generated from corresponding training audio data 532 of the meetings as well as evaluate how effectively the digital transcription neural network 502 is learning to extract contextual information about the meetings from the corresponding training meeting context data 534. In particular, the transcription training loss model 510 compares the digital transcript 404 to corresponding training transcripts 536 to determine a transcription error amount 512.

Upon determining the transcription error amount 512, the digital transcription system 104 can back propagate the transcription error amount 512 to the input layers 504, the hidden layers 506, and the output layers 508 to tune and fine-tune the weights and parameters of these layers to learn to better extract context information from the training meeting context data 534 as well as generate more accurate digital transcripts. Further, the digital transcription system 104 can train the digital transcription neural network 502 in batches until the network converges, the transcription error amount 512 drops below a threshold amount, or the digital transcripts are above a threshold accuracy level (e.g., 95% accurate).

Even after the digital transcription neural network 502 is initially trained, the digital transcription system 104 can continue to fine-tune the digital transcription neural network 502. To illustrate, a user may provide the digital transcription neural network 502 with an edited or updated version of a digital transcript generated by the digital transcription neural network 502. In response, the digital transcription system 104 can utilize the updated version of the digital transcript to further improve the speech recognition prediction capabilities of the digital transcription neural network 502.

In some embodiments, the digital transcription system 104 can generate at least a portion of the transcription training data 530. To illustrate, the digital transcription system 104 accesses digital documents corresponding to one or more users. Upon accessing the digital documents, the digital transcription system 104 utilizes a text-to-speech synthesizer to generate the training audio data 532 by reading and recording the text of the digital document. In this manner, the accessed digital document (i.e., meeting context data) itself serves as the ground truth for the corresponding training audio data 532.

Further, the digital transcription system 104 can supplement training data with multi-modal data sets that include training audio data coupled with training transcripts. To illustrate, in various embodiments, the digital transcription system 104 initially trains the digital transcription neural network 502 to recognize speech. For example, the digital transcription system 104 utilizes the multi-modal data sets (e.g., a digital document with audio from a text-to-speech algorithm) to train the digital transcription neural network 502 to perform speech-to-text operations. Then, in a second training stage, the digital transcription system 104 trains the digital transcription neural network 502 with the transcription training data 530 to learn how to improve digital transcripts based on the meeting context data of a meeting participant.

In additional embodiments, the digital transcription system 104 trains the digital transcription neural network 502 to better recognize the voice of a meeting participant. For example, one or more meeting participants reads a script that provides the digital transcription neural network 502 with both training audio data and a corresponding digital transcript (e.g., ground truth). Then, when the user is detected speaking in the meeting, the digital transcription system 104 learns to understand the user's speech patterns (e.g., rate of speech, accent, pronunciation, cadence, etc.). Further, the digital transcription system 104 improves accuracy of the digital transcript by weighting words spoken by the user with meeting context data most closely associated with the user.

In various embodiments, the digital transcription system 104 utilizes training video data in addition to the training audio data 532 to train the digital transcription neural network 502. The training video data includes visual and labeled speaker information that enables the digital transcription neural network 502 to increase the accuracy of the digital transcript. For example, the training video data provides speaker information that enables the digital transcription neural network 502 to disambiguate unsure speech, such as detect the speaker based on lip movement, which speaker is saying what when multiple speakers talk at the same time, and/or the emotion of a speaker based on facial expression (e.g., the speaker is telling a joke or is very serious), each of which can be noted in the digital transcript 404.

As detailed above, the digital transcription system 104 utilizes the trained digital transcription neural network 502 to generate highly accurate digital transcripts from at least one recording of audio data of a meeting and meeting context data. In one or more embodiments, upon providing the digital transcript to one or more meeting participants, the digital transcription system 104 enables users to search the digital transcript by keyword or phrases.

In additional embodiments, the digital transcription system 104 also enables phonetic searching of words. For example, the digital transcription system 104 labels each word in the digital transcript with the phonetic sound recognized in the audio data. In this manner, the digital transcription system 104 enables users to find words or phrases were pronounced in a meeting even if the digital transcription system 104 uses a different word for the digital transcript, such as when new words are acronyms are made up in a meeting.

Turning now to FIG. 6, this figure illustrates a client device 600 having a graphical user interface 602 that includes a meeting agenda 610 and a meeting calendar item 620 in accordance with one or more embodiments. As mentioned above, the digital transcription system 104 can obtain event details from a variety of digital documents. Further, in some embodiments, the digital transcription system 104 utilizes the event details to identify meeting subjects and/or filter digital documents that best correspond to the meeting.

As shown, the meeting agenda 610 includes event details about a meeting, such as the participants, location, date and time, and subjects. The meeting agenda 610 can include additional details such as job position, job description, minutes or notes from previous meetings, follow-up meeting dates and subjects, etc. Similarly, the meeting calendar item 620 includes event details such as the subject, organizer, participants, location, and date and time of the meeting. In some instances, the meeting calendar item 620 also provides notes and/or additional comments about the meeting (e.g., topics to be discussed, assignments, attachments, links, call-in instructions, etc.).

In one or more embodiments, the digital transcription system 104 automatically detects the meeting agenda 610 and/or the meeting calendar item 620 from the digital documents within the meeting context data for an identified meeting participant. For example, the digital transcription system 104 correlates the meeting time and/or location from the audio data with the date, time, and/or location indicated in the meeting agenda 610. In this manner, the digital transcription system 104 can identify the meeting agenda 610 as a relevant digital document with event details.

In another example, the digital transcription system 104 determines that the time of the meeting calendar item 620 matches the time that the audio data was captured. For instance, the digital transcription system 104 has access to, or manages the meeting calendar item 620 for a meeting participant. Further, if a meeting participant utilizes a client application associated with the digital transcription system 104 on their client device to capture the audio data of the meeting at the time of the meeting calendar item 620, the digital transcription system 104 can automatically associate the meeting calendar item 620 with the audio data for the meeting.

In alternative embodiments, the meeting participant manually provides the meeting agenda 610 and/or confirms that the meeting calendar item 620 correlates with the audio data of the meeting. For example, the digital transcription system 104 provides a user interface in a client application that receives user input of both the audio data of the meeting and the meeting agenda 610 (as well as input of other meeting context data). As another example, a client application associated with the digital transcription system 104 is providing the meeting agenda 610 to a meeting participant, who then utilizes the client application to record the meeting and capture the audio data. In this manner, the digital transcription system 104 automatically associates the meeting agenda 610 with the audio data for the meeting.

As mentioned previously, the digital transcription system 104 can extract a subject from the meeting agenda 610 and/or meeting calendar item 620. For example, the digital transcription system 104 identifies the subject of the meeting from the meeting calendar item 620 (e.g., the subject field) or from the meeting agenda 610 (e.g., a title or header field). Further, the digital transcription system 104 can parse the meeting subject to identify at least one topic of the meeting (e.g., engineering meeting).

In some embodiments, the digital transcription system 104 infers a subject from the meeting agenda 610 and/or meeting calendar item 620. For example, the digital transcription system 104 identifies job positions and descriptions for the meeting participants. Then, based on the combination of job positions, job descriptions, and/or user assignments, the digital transcription system 104 infers a subject (e.g., the meeting is likely an invention disclosure meeting because it includes lawyers and engineers).

As described above, in various embodiments, the digital transcription system 104 utilizes the identified meeting subject to filter and/or weight digital documents received from one or more meeting participants. For instance, the digital transcription system 104 identifies and retrieves all digital documents from a meeting participant that correspond to the identified meeting subject. In some embodiments, the digital transcription system 104 identified a previously created digital lexicon that corresponds to the meeting subject, and in some cases, also corresponds to one or more of the meeting participants.

As mentioned above, the digital transcription system 104 can utilize the meeting agenda 610 and/or the meeting calendar item 620 to identify additional meeting participants, for example, from the participants list. Then, in some embodiments, the digital transcription system 104 accesses additional meeting context data of the additional meeting participants, as explained earlier. Further, in various embodiments, upon accessing meeting context data corresponding to multiple meeting participants, if the digital transcription system 104 identifies digital documents relating to the meeting subject stored by each of the meeting participants (or shared across the meeting participants), the digital transcription system 104 can assign a higher relevance weight to those digital documents as corresponding to the meeting.

In some embodiments, the meeting agenda 610 and/or the meeting calendar item 620 provide indications as to which meeting participants has the most relevant meeting context data for the meeting. For example, the meeting organizer, the first listed participant, and/or one of the first listed participants may maintain a more complete set of digital documents or have more relevant user features with respect to the meeting. Similarly, a meeting presenter may have additional digital documents corresponding to the meeting that are not kept by other meeting participants. The digital transcription system 104 can weight documents or other meeting context data corresponding to more relevant, experienced, or knowledgeable participants.

The digital transcription system 104 can also apply different weights based on the proximity or affinity of digital documents (or other meeting context data). For example, in one or more embodiments, the digital transcription system 104 provides a first weight to words found in the meeting agenda 610. The digital transcription system 104 then applies a second (lower) weight to words found in digital documents within the same folder as the meeting agenda 610. Moreover, the digital transcription system 104 further assigns a third (still lower) weight to words in digital documents in a parent folder. In this manner, the digital transcription system 104 can apply weights according to the tree-like folder structure in which the digital documents are stored.

As another example, in various embodiments, the digital transcription system 104 applies a first weight to words found in digital documents authored by the user and/or meeting participants. In addition, the digital transcription system 104 can apply a second (lower) weight to words found in other digital documents authored by the immediate teammates of the meeting participants. Further, the digital transcription system 104 can apply a third (still lower) weight to words in digital documents authored by others within the same organization.

Turning now to FIG. 7, additional detail is provided regarding automatically redacting sensitive information from a digital transcript. To illustrate, FIG. 7 shows a sequence diagram of providing redacted digital transcripts to users in accordance with one or more embodiments. In particular, FIG. 7 includes the digital transcription system 104 on the server device 101, a first client device 108a, and a second client device 108b. The server device 101 in FIG. 7 can correspond the server device 101 described above with respect to FIG. 1. Similarly, the first client device 108a and the second client device 108b in FIG. 7 can correspond to the client devices 108a-108n described above.

As shown in FIG. 7, the digital transcription system 104 performs an act 702 of generating generates a digital transcript of a meeting. In particular, the digital transcription system 104 generates a digital transcript from audio data of a meeting as described above. For example, the digital transcription system 104 utilizes the digital transcription model 106 to generate a digital transcript of a meeting based on audio data of the meeting and meeting context data.

In addition, the digital transcription system 104 performs an act 704 of receiving a first request for the digital transcript from the first client device 108a. For instance, a first user associated with the first client device 108a requests a copy of the digital transcript from the digital transcription system 104. In some embodiments, the first user participated in the meeting and/or provided the audio data of the meeting. In alternative embodiments, the first user is requesting a copy of the digital transcript of the meeting without having attended the meeting.

As shown, the digital transcription system 104 also performs an act 706 of determining an authorization level of the first user. The level of authorization can correspond to whether the digital transcription system 104 provides a redacted copy of the digital transcript to the first user and/or which portions of the digital transcript to redact. The first user may have full-authorization rights, partial-authorization rights, or no authorization rights, where authorization rights determine a user's authorization level.

In one or more embodiments, the digital transcription system 104 determines the authorization level of the first user based on one or more factors. As one example, the level of authorization rights can be tied to a user's job description or title. For instance, a project manager or company principal may be provided a higher authorization level than a designer or an associate. As another example, the level of authorization rights can be tied to a user's meeting participation. For example, if the user attended and/or participated in the meeting, the digital transcription system 104 grants authorization rights to the user. Similarly, if a user spoke in the meeting, the digital transcription system 104 can leave portions of the digital transcript where the user was speaking unredacted. Further, if the user participated in past meetings sharing the same context, the digital transcription system 104 grants authorization rights to the user.

As shown, the digital transcription system 104 performs an act 708 of generating a first redacted copy of the meeting based on the first user's authorization level. In one or more embodiments, the digital transcription system 104 generates a redacted copy of the digital transcript from an unredacted copy of the digital transcript. In alternative embodiments, the digital transcription system 104 (e.g., the digital transcription model 106) generates a redacted copy of the digital transcript directly from the audio data of the meeting based on the first user's authorization level.

The digital transcription system 104 can generate the redacted copy of the digital transcript to exclude confidential and/or sensitive information. For example, the digital transcription system 104 redacts topics, such as budgets, compensation, user assessments, personal issues, or other previously redacted topics. In addition, the digital transcription system 104 redacts (or filters) topics not related to the primary context (or secondary contexts) of the meetings such that the redacted copied provides a streamlined version of the meeting.

In one or more embodiments, the digital transcription system 104 utilizes a heuristic function that detects redaction cues in the meeting from the audio data or unredacted transcribed copy of the digital transcript. For example, the keywords “confidential,” “sensitive,” “off the record,” “pause the recording,” etc., trigger an alert for the digital transcription system 104 to identify portions of the meeting to redact. Similarly, the digital transcription system 104 identifies previously redacted keywords or topics. In addition, the digital transcription system 104 identifies user input on a client device that provides a redaction indication.

In one or more embodiments, the digital transcription system 104 can redact one or more words, sentences, paragraphs, or sections in the digital transcript located before or after a redaction cue. For example, the digital transcription system 104 analyzes the words around the redaction cue to determine which words, and to what extent to redact. For instance, the digital transcription system 104 determines that a user's entire speaking turn is discussing a previously redacted topic. Further, the digital transcription system 104 can determine that multiple speakers are discussing a redacted topic for multiple speaking turns.

In alternative embodiments, the digital transcription system 104 utilizes a machine-learning model to generate a redacted copy of the meeting. For example, the digital transcription system 104 provides training digital transcripts redacted at various authorization levels to a machine-learning model (e.g., a transcript redaction neural network) to train the network to redact content from the meeting based on a user's authorization level.

As shown, the digital transcription system 104 performs an act 710 of providing the first redacted copy of the digital transcript to the first user via the first client device 108a. In one or more embodiments, the first redacted copy of the digital transcript can show portions of the meeting that were redacted, such as by blocking out the redacted portions. In alternative embodiments, the digital transcription system 104 excludes redacted portions of the first redacted copy of the digital transcript, with or without an indication that the portions have been redacted.

In optional embodiments, the digital transcription system 104 provides the first redacted copy of the digital transcript to an administrating user with full authorization rights for review and approval prior to providing the copy to the first user. For example, the digital transcription system 104 provides a copy of the first digital transcript to the administrating user indicating the portions that are being redacted for the first user. The administrating user can confirm, modify, add, and remove redacted portions from the first redacted copy of the digital transcript before it is provided to the first user.

As shown, the digital transcription system 104 performs an act 712 of receiving a second request for the digital transcript from the second client device 108b. For example, a second user associated with the second client device requests a copy of the digital transcript of the meeting from the digital transcription system 104. In some embodiments, the second user requests a copy of the digital transcript from with a client application on the second client device 108b.

As shown, after receiving the second request, the digital transcription system 104 performs an act 714 of determining an authorization level of the second user. Determining user authorization levels for a user is described above. In addition, for purposes of explanation, the digital transcription system 104 determines that the second user has a different authorization level than the first user.

Based on determining that the second user has a different authorization level than the first, the digital transcription system 104 performs an act 716 of generating a second redacted copy of the digital transcript based on the second user's authorization level. For example, the digital transcription system 104 allocates a sensitivity rating to each portion of the meeting and utilizes the sensitivity rating to determine which portions of the meeting to include in the second redacted copy of the digital transcript. In this manner, the two redacted copies of the digital transcript generated by the digital transcription system 104 include different amounts of redacted content based on the respective authorization levels of the two users.

As shown, the digital transcription system 104 performs an act 718 of providing the second redacted copy of the digital transcript to the second user via the second client device 108b. As described above, the second redacted copy of the digital transcript can indicate the portions of the meeting that were redacted. In addition, the digital transcription system 104 can enable the second user to request that one or more portions of the second redacted copy of the digital transcript of the meeting be removed.

In various embodiments, the digital transcription system 104 automatically provides redacted copies of the digital transcript to meeting participants and/or other users associated with the meeting. In these embodiments, the digital transcription system 104 can generate and provide redacted copies of the digital transcript of the meeting without first receiving individual user requests.

Additionally, in one or more embodiments, the digital transcription system 104 can create redacted copies of the audio data for one or more users. For example, the digital transcription system 104 redacts portions of the audio data that correspond to the redacted portions of the digital transcript copies (e.g., per user). In this manner, the digital transcription system 104 prevents users from circumventing the redacted copies of the digital transcript to obtain unauthorized access to sensitive information.

As mentioned above, the digital transcription system 104 can utilize a collaboration graph to locate, gather, analyze, filter, and/or weigh meeting context data of one or more users. FIG. 8 illustrates an example collaboration graph 800 of a digital content management system in accordance with one or more embodiments. In one or more embodiments, the digital transcription system 104 generates, maintains, modifies, stores, and/or implements one or more collaboration graphs in one or more data stores. Notably, while the collaboration graph 800 is shown as a two-dimensional visual map representation, the collaboration graph 800 can include any number of dimensions.

For ease of explanation, the collaboration graph 800 corresponds to a single entity (e.g., company or organization). However, in some embodiments, the collaboration graph 800 connects multiple entities together. In alternative embodiments, the collaboration graph 800 corresponds to a portion of an entity, such as users working on a projects.

As shown, the collaboration graph 800 includes multiple nodes 802-810 including user nodes 802 associated with users of an entity as well as concept nodes 804-810. Examples of concept nodes shown include project nodes 804, document set nodes 806, location nodes 808, and application nodes 810. While a limited number of concept nodes are shown, the collaboration graph 800 can include any number of different concepts nodes.

In addition, the collaboration graph 800 includes multiple edges 812 connecting the nodes 812-816. The edges 812 can provide a relational connection between two nodes. For example, the edge 812 connects the user node of “User A” with the concept node of “Project A” with the relational connection of “works on.” Accordingly, the edge 812 indicates that User A works on Project A.

As mentioned above, the digital transcription system 104 can employ the collaboration graph 800 in connection with a user's context data. For example, the digital transcription system 104 locates the user within the collaboration graph 800 and identifies other nodes adjacent to the user as well as how the user is connected to those adjacent nodes (e.g., a user's personal graph). To illustrate, User A (i.e., the user node 802) works on Project A and Project B, accesses Document Set A, and created Document Set C. Thus, when retrieving meeting context data for User A, the digital transcription system 104 can access content associated with one or more of these concept nodes (in addition to other digital documents, user features, and/or event details associated with the user).

In some embodiments, the digital transcription system 104 can access content associated with nodes within a threshold node distance of the user (e.g., number of hops). For example, the digital transcription system 104 accesses any node within three hops of the user node 802 as part of the user's context data. In this example, the digital transcription system 104 accesses content associated with every node in the collaboration graph 800 except for the node of “Document Set B.”

In one or more embodiments, as the distance grows between the initial user node and a given node (e.g., for each hop away from the initial user node), the digital transcription system 104 reduces the relevance weights assigned to the content in the given node (e.g., weighting based on collaboration graph 800 reach). To illustrate, the digital transcription system 104 assigns 100% weight to nodes within a distance of two hops of the user node 802. Then, for each additional hop, the digital transcription system 104 reduces the assigned relevance weight by 20%.

In alternative embodiments, the digital transcription system 104 assigns full weight to all nodes in the collaboration graph 800 when retrieving context data for a user. For example, the digital transcription system 104 employs the collaboration graph 800 for the organization as a whole as a default graph when a user is not associated with enough meeting context data. In other embodiments, the digital transcription system 104 maintains a default graph that is a subset of the collaboration graph 800, which the digital transcription system 104 utilizes when a user's personal graph is insufficient. Further, the digital transcription system 104 can maintain subject-based default graphs, such as a default engineering graph (including engineering users, projects, document sets, and applications) or a default sales graph.

In some embodiments, rather than selecting a user node as the initial node (e.g., to form a personal graph), the digital transcription system 104 selects another concept node, such as a project node (e.g., to form a project graph) or a document set node (e.g., to form a document set graph), or a meeting node. For example, the digital transcription system 104 first identifies a project node from event details of a meeting associated with the user. Then, the digital transcription system 104 utilizes the collaboration graph 800 to identify digital documents and/or other context data associated with the meeting.

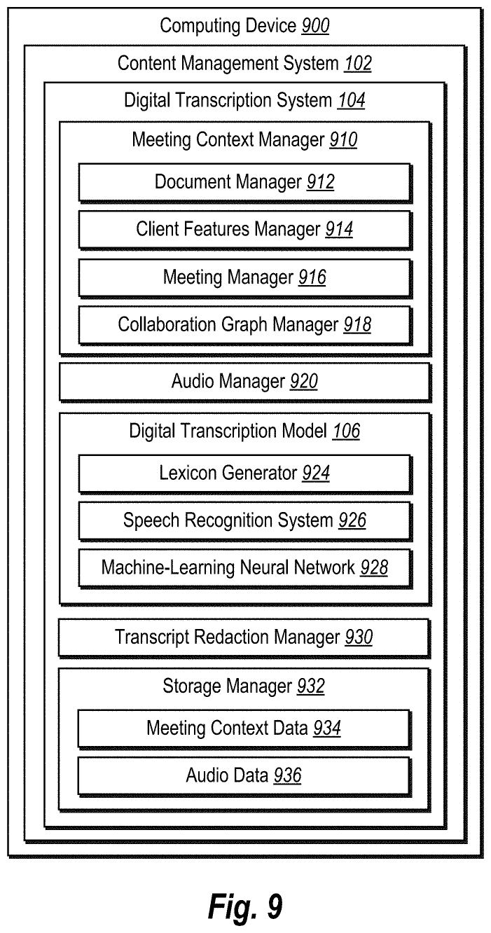

Turning now to FIG. 9, additional detail is provided regarding components and capabilities of example architecture for the digital transcription system 104 that may be implemented on a computing device 900. In one or more embodiments, the computing device 900 is an example of the server device 101 or the first client device 108a described with respect to FIG. 1, or a combination thereof.

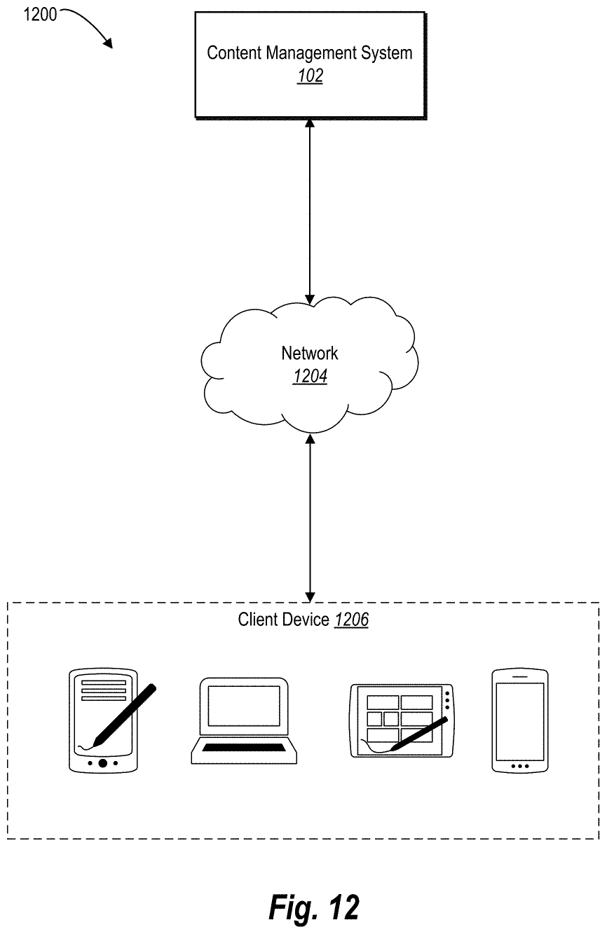

As shown, the computing device 900 includes the content management system 102 having the digital transcription system 104. In one or more embodiments, the content management system 102 refers to a remote storage system for remotely storing digital content item on a storage space associated with a user account. As described above, the content management system 102 can maintain a hierarchy of digital documents in a cloud-based environment (e.g., local or remotely) and provide access to given digital documents for users. Additional detail regarding the content management system 102 is provided below with respect to FIG. 12.

The digital transcription system 104 includes a meeting context manager 910, an audio manager 920, the digital transcription model 106, a transcript redaction manager 930, and a storage manager 932, as illustrated. In general, the meeting context manager 910 manages the retrieval of meeting context data. As also shown, the meeting context manager 910 includes a document manager 912, a user features manager 914, a meeting manager 916, and a collaboration graph manager 918. The meeting context manager 910 can store and retrieve meeting context data 934 from a database maintained by the storage manager 932.

In one or more embodiments, the document manager 912 facilitates the retrieval of digital documents. For example, upon identifying a meeting participant, the document manager 912 accesses one or more digital documents from the content management system 102 associated with the user. In various embodiments, the document manager 912 also filters or weights digital documents in accordance with the above description.

The user features manager 914 identifies one or more user features of a user. In some embodiments, the user features manager 914 utilizes user features of a user to identify relevant digital documents associated with the user and/or a meeting, as described above. Examples of user features are provided above in connection with FIG. 4A.

The meeting manager 916 accesses event details of a meeting corresponding to audio data. For instance, the meeting manager 916 correlates audio data of a meeting to meeting participants and/or event details, as described above. In some embodiments, the meeting manager 916 stores (e.g., locally or remotely) identifies event details from copies of meeting agendas or meeting event items.

In one or more embodiments, the collaboration graph manager 918 maintains a collaboration graph that includes a relational mapping of users and concepts for an entity. For example, the collaboration graph manager 918 creates, updates, modifies, and accesses the collaboration graph of an entity. For instance, the collaboration graph manager 918 accesses all nodes within a threshold distance of an initial node (e.g., the node of the identified meeting participant). In some embodiments, the collaboration graph manager 918 generates a personal graph from a subset of nodes of a collaboration graph that is based on a given user's node. Similarly, the collaboration graph manager 918 can create project graphs or document set graphs that center around a given project or document set node in the collaboration graph. An example of a collaboration graph is provided in FIG. 8.

As shown, the digital transcription system 104 includes the audio manager 920. In various embodiments, the audio manager 920 captures, receives, maintains, edits, deletes, and/or distributes audio data 936 of a meeting. For example, in one or more embodiments, the audio manager 920 records a meeting from at least one microphone on the computing device 900. In alternative embodiments, the audio manager 920 receives audio data 936 of a meeting from another computing device, such as a user's client device. In some embodiments, the audio manager 920 stores the audio data 936 in connection with the storage manager 932. Further, in some embodiments, the audio manager 920 pre-processes audio data as described above. Additionally, in one or more embodiments, the audio manager 920 discards, archives, or reduces the size of an audio recording after a predetermined amount of time.

As also shown, the digital transcription system 104 includes the digital transcription model 106. As described above, the digital transcription system 104 utilizes the digital transcription model 106 to generate a digital transcript of a meeting based on the meeting context data 934. As also described above in detail, the digital transcription model 106 can operate heuristically or one or more trained machine-learning neural networks. As illustrated, the digital transcription model 106 includes a lexicon generator 924, a speech recognition system 926, and a machine-learning neural network 928.

In various embodiments, the lexicon generator 924 generates a digital lexicon based on the meeting context data 934 for one or more users that participated in a meeting. Embodiments of the lexicon generator 924 are described above with respect to FIG. 4A. In addition, as described above, the speech recognition system 926 generates the digital transcript from audio data and a digital lexicon. In some embodiments, the speech recognition system 926 is integrated into the digital transcription system 104 on the computing device 900. In other embodiments, the speech recognition system 926 is located remote from the digital transcription system 104 and/or maintained by a third party.

As shown, the digital transcription model 106 includes a machine-learning neural network 928. In one or more embodiments, the machine-learning neural network 928 is a digital lexicon neural network that generates digital lexicons, such as described with respect to FIG. 4B. In some embodiments, the machine-learning neural network 928 is a digital transcription neural network that generates digital transcripts, such as described with respect to FIG. 5B.

The digital transcription model 106 also includes the transcript redaction manager 930. In various embodiments, the transcript redaction manager 930 receives a request for a digital transcript of a meeting, determines whether the digital transcript should be redacted based on the requesting user's authorization rights, generates a redacted digital transcript, and provides a redacted copy of the digital transcript of the meeting in response to the request. In particular, the transcript redaction manager 930 can operate in accordance with the description above with respect to FIG. 7.

The components 910-936 can include software, hardware, or both. For example, the components 910-936 include one or more instructions stored on a computer-readable storage medium and executable by processors of one or more computing devices, such as a client device or server device. When executed by the one or more processors, the computer-executable instructions of the computing device 900 and/or digital transcription system 104 can cause the computing device(s) to perform the feature learning methods described herein. Alternatively, the components 910-936 can include hardware, such as a special-purpose processing device to perform a certain function or group of functions. Alternatively, the components 910-936 can include a combination of computer-executable instructions and hardware.

Furthermore, the components 910-936 are, for example, implemented as one or more operating systems, as one or more stand-alone applications, as one or more modules of an application, as one or more plug-ins, as one or more library functions or functions called by other applications, and/or as a cloud computing model. Thus, the components 910-936 can be implemented as a stand-alone application, such as a desktop or mobile application. Furthermore, the components 910-936 can be implemented as one or more web-based applications hosted on a remote server. The components 910-936 can also be implemented in a suite of mobile device applications or “apps.”

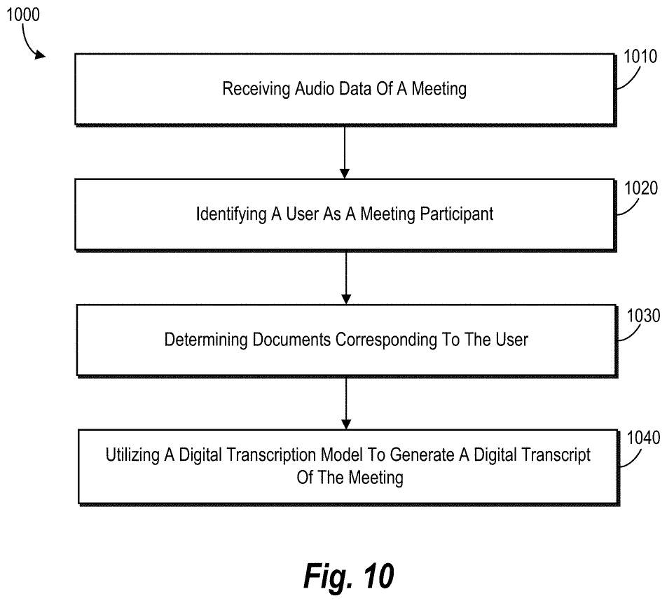

FIGS. 1-9, the corresponding text, and the examples provide several different systems, methods, techniques, components, and/or devices of the digital transcription system 104 in accordance with one or more embodiments. In addition to the above description, one or more embodiments can also be described in terms of flowcharts including acts for accomplishing a particular result. For example, FIG. 10 illustrates flowcharts of an example sequence of acts in accordance with one or more embodiments. In addition, FIG. 10 may be performed with more or fewer acts. Further, the acts may be performed in differing orders. Additionally, the acts described herein may be repeated or performed in parallel with one another or parallel with different instances of the same or similar acts.

While FIG. 10 illustrates series of acts 1000 according to particular embodiments, alternative embodiments may omit, add to, reorder, and/or modify any of the acts shown. The series of acts of FIG. 10 can be performed as part of a method. Alternatively, a non-transitory computer-readable medium can comprise instructions, when executed by one or more processors, cause a computing device (e.g., a client device and/or a server device) to perform the series of acts of FIG. 10. In still further embodiments, a system performs the acts of FIG. 10.

To illustrate, FIG. 10 shows a flowchart of a series of acts 1000 of utilizing a digital transcription model to generate a digital transcript of a meeting in accordance with one or more embodiments. As shown, the series of acts 1000 includes the act 1010 of receiving audio data of a meeting. In one or more embodiments, the act 1010 includes receiving, from a client device, audio data of a meeting attended by a user. In some embodiments, the act 1010 includes receiving audio data of a meeting having multiple participants.

As shown, the series of acts 1000 includes the act 1020 of identifying a user as a meeting participant. In one or more embodiments, the act 1020 includes identifying a digital event item (e.g., a meeting calendar event) associated with the meeting and parsing the digital event item to identify the user as the participant of the meeting. In some embodiments, the act 1020 includes identifying the user as the participant of the meeting from a digital document associated with the meeting. In additional embodiments, the digital document associated with the meeting includes a meeting agenda that indicates meeting participants, a meeting location, a meeting time, and a meeting subject.

The series of acts 1000 also includes an act 1030 of determining documents corresponding to the user. In particular, the act 1030 can involve determining one or more digital documents corresponding to the user in response to identifying the user as the participant of the meeting. In some embodiments, the act 1030 includes identifying one or more digital documents associated with a user prior to the meeting (e.g., not in response to identifying the user as the participant of the meeting). In various embodiments, the act 1030 includes identifying one or more digital documents corresponding to the meeting upon receiving the audio data of the meeting.

In one or more embodiments, the act 1030 includes parsing one or more digital documents to identify words and phrases utilized within the one or more digital documents, generating a distribution of the words and phrases utilized within the one or more digital documents, weighting the words and phrases utilized within the one or more digital documents based on a meeting subject, and generating a digital lexicon associated with the user based on the distribution and weighting of the words and phrases utilized within the one or more digital documents.

Additionally, the series of acts 1000 includes an act 1040 of utilizing a digital transcription model to generate a digital transcript of the meeting. In particular, in various embodiments, the act 1040 can involve utilizing a digital transcription model to generate a digital transcript of the meeting based on the audio data and the one or more digital documents corresponding to the user.

In some embodiments, the act 1040 includes accessing additional digital documents corresponding to one or more additional users that are participants of the meeting and utilizing the additional digital documents corresponding to one or more additional users that are participants of the meeting to generate the digital transcript. In various embodiments, the act 1040 includes determining user features corresponding to the user and generating the digital transcript of the meeting based on the user features corresponding to the user. In additional embodiments, the user features corresponding to the user include a job position held by the user.

In various embodiments, the act 1040 includes identifying one or more additional users as participants of the meeting; determining, from a collaboration graph, additional digital documents corresponding to the one or more additional users; and generating the digital transcript of the meeting further based on the additional digital documents corresponding to the one or more additional users. In some embodiments, the act 1040 includes identifying a portion of the audio data that includes a spoken word, detecting a plurality of potential words that correspond to the spoken word, weighting a prediction probability of each of the potential words utilizing a digital lexicon associated with the user, and selecting the potential word having the most favorable weighted prediction probability of representing the spoken word in the digital transcript.

In one or more embodiments, the act 1040 includes determining, from a collaboration graph, additional digital documents corresponding to the meeting; and generating the digital transcript of the meeting further based on the additional digital documents corresponding to the meeting. In some embodiments, the act 1040 includes analyzing the one or more digital documents to generate a digital lexicon associated with the user. In additional embodiments, the act 1040 includes accessing the digital lexicon associated with the user in response to identifying the user as a participant of the meeting and utilizing the digital transcription model to generate the digital transcript of the meeting based on the audio data and the digital lexicon associated with the user.

Similarly, in one or more embodiments, the act 1040 includes generating a digital lexicon associated with the meeting by analyzing the one or more digital documents corresponding to the user. In additional embodiments, the act 1040 includes generating the digital transcript of the meeting utilizing the audio data and the digital lexicon associated with the meeting. In various embodiments, the act 1040 includes accessing a digital lexicon associated with the meeting and generating the digital transcript of the meeting based on the audio data and the digital lexicon associated with the meeting.

In some embodiments, the act 1040 includes analyzing the one or more digital documents to generate an additional (e.g., second) digital lexicon associated with the user, determining that the first digital lexicon associated with the user corresponds to a first subject and that the second digital lexicon associated with the user corresponds to a second subject, and utilizing the first digital lexicon to generate the digital transcript of the meeting based on determining that the meeting corresponds to the first subject. In additional embodiments, the act 1040 includes utilizing the second digital lexicon to generate a second digital transcript of the meeting based on determining that the meeting subject changed to the second subject.

In various embodiments, the act 1040 includes utilizing the trained digital transcription neural network to generate the digital transcript of the meeting based on the audio data and the one or more digital documents corresponding to the meeting user. For example, the audio data is a first input and the one or more digital documents is a second input to the digital transcription neural network.

In some embodiments, training the digital transcription neural network includes generating synthetic audio data from a plurality of digital training documents corresponding to a meeting subject utilizing a text-to-speech model, providing the synthetic audio data to the digital transcription neural network, and training the digital transcription neural network utilizing the digital training documents as a ground-truth to the synthetic audio data.

In one or more embodiments, the series of acts 1000 includes additional acts, such as the act of providing the digital transcript of the meeting to a client device associated with a user. In some embodiments, the series of acts 1000 includes the acts of receiving, from a client device associated with the user, a request for a digital transcript; determining an access level of the user; and redacting portions of the digital transcript based on the determined access level of the user and audio cues detected in the audio data. In additional embodiments, providing the digital transcript of the meeting to the client device associated with the user includes providing the redacted digital transcript.

Embodiments of the present disclosure can include or utilize a special-purpose or general-purpose computer including computer hardware, such as, for example, one or more processors and system memory, as discussed in additional detail below. Embodiments within the scope of the present disclosure also include physical and other computer-readable media for carrying or storing computer-executable instructions and/or data structures. In particular, one or more of the processes described herein can be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media accessible by a general-purpose or special-purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can include at least two distinctly different kinds of computer-readable media: non-transitory computer-readable storage media (devices) and transmission media.

Non-transitory computer-readable storage media (devices) includes RAM, ROM, EEPROM, CD-ROM, solid-state drives, Flash memory, phase-change memory, other types of memory, other optical disk storage, magnetic disk storage or other magnetic storage devices, or any other medium used to store desired program code means in the form of computer-executable instructions or data structures, and accessible by a general-purpose or special-purpose computer.

Computer-executable instructions include, for example, instructions and data which, when executed by a processor, cause a general-purpose computer, special-purpose computer, or special-purpose processing device to perform a certain function or group of functions. In some embodiments, a general-purpose computer executes computer-executable instructions to turn the general-purpose computer into a special-purpose computer implementing elements of the disclosure. The computer-executable instructions can be, for example, binaries, intermediate format instructions such as assembly language, or even source code. Although the subject matter has been described in language specific to structural features and/or methods, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud computing model can be composed of various characteristics such as, for example, on-demand self-service, broad network access, resource pooling, rapid elasticity, measured service, and so forth. A cloud computing model can also expose various service models, such as, for example, Software as a Service (“SaaS”), Platform as a Service (“PaaS”), and Infrastructure as a Service (“IaaS”). A cloud computing model can also be deployed using different deployment models such as private cloud, community cloud, public cloud, hybrid cloud, and so forth. In this description and the claims, a “cloud computing environment” is an environment in which cloud computing is employed.

FIG. 11 illustrates a block diagram of an example computing device 1100 that can be configured to perform one or more of the processes described above. One or more computing devices, such as the computing device 1100 can represent the server device 101, client devices 108a-108n, 304-308, 600, and computing devices 400, 900 described above. In one or more embodiments, the computing device 1100 can be a non-mobile device (e.g., a desktop computer or another type of client device). In some embodiments, the computing device 1100 can be a mobile device (e.g., a mobile telephone, a smartphone, a PDA, a tablet, a laptop, a camera, a tracker, a watch, a wearable device, etc.). Further, the computing device 1100 can be a server device that includes cloud-based processing and storage capabilities.

As shown in FIG. 11, the computing device 1100 can include one or more processor(s) 1102, memory 1104, a storage device 1106, input/output (“I/O”) interfaces 1108, and a communication interface 1110, which can be communicatively coupled by way of a communication infrastructure (e.g., bus 1112). While the computing device 1100 is shown in FIG. 11, the components illustrated in FIG. 11 are not intended to be limiting. Additional or alternative components can be used in other embodiments. Furthermore, in certain embodiments, the computing device 1100 includes fewer components than those shown in FIG. 11. Components of the computing device 1100 shown in FIG. 11 will now be described in additional detail.

In particular embodiments, the processor(s) 1102 includes hardware for executing instructions, such as those making up a computer program. As an example, and not by way of limitation, to execute instructions, the processor(s) 1102 can retrieve (or fetch) the instructions from an internal register, an internal cache, memory 1104, or a storage device 1106 and decode and execute them. In particular embodiments, processor 1102 may include one or more internal caches for data, instructions, or addresses. As an example and not by way of limitation, processor 1102 may include one or more instruction caches, one or more data caches, and one or more translation lookaside buffers (TLBs). Instructions in the instruction caches may be copies of instructions in memory 1104 or storage 1106.

The computing device 1100 includes memory 1104, which is coupled to the processor(s) 1102. The memory 1104 can be used for storing data, metadata, and programs for execution by the processor(s). The memory 1104 can include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1104 can be internal or distributed memory.

The computing device 1100 includes a storage device 1106 includes storage for storing data or instructions. As an example, and not by way of limitation, the storage device 1106 can include a non-transitory storage medium described above. The storage device 1106 can include a hard disk drive (HDD), flash memory, a Universal Serial Bus (USB) drive or a combination these or other storage devices.

As shown, the computing device 1100 includes one or more I/O interfaces 1108, which are provided to allow a user to provide input to (such as digital strokes), receive output from, and otherwise transfer data to and from the computing device 1100. These I/O interfaces 1108 can include a mouse, keypad or a keyboard, a touchscreen, camera, optical scanner, network interface, modem, other known I/O devices or a combination of the I/O interfaces 1108. The touchscreen can be activated with a stylus or a finger.

The I/O interfaces 1108 can include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interfaces 1108 are configured to provide graphical data to a display for presentation to a user. The graphical data can be representative of one or more graphical user interfaces and/or any other graphical content as can serve a particular implementation.

The computing device 1100 can further include a communication interface 1110. The communication interface 1110 can include hardware, software, or both. The communication interface 1110 provides one or more interfaces for communication (such as, for example, packet-based communication) between the computing device and one or more other computing devices or one or more networks. As an example, and not by way of limitation, communication interface 1110 can include a network interface controller (NIC) or network adapter for communicating with an Ethernet or other wire-based network or a wireless NIC (WNIC) or wireless adapter for communicating with a wireless network, such as a WI-FI. The computing device 1100 can further include a bus 1112. The bus 1112 can include hardware, software, or both that connects components of computing device 1100 to each other.

FIG. 12 is a schematic diagram illustrating environment 1200 within which the digital transcription system 104 described above can be implemented. The content management system 102 may generate, store, manage, receive, and send digital content (such as digital videos). For example, the content management system 102 may send and receive digital content to and from the client devices 1206 by way of the network 1204. In particular, the content management system 102 can store and manage a collection of digital content. The content management system 102 can manage the sharing of digital content between computing devices associated with a plurality of users. For instance, the content management system 102 can facilitate a user sharing digital content with another user of the content management system 102.

In particular, the content management system 102 can manage synchronizing digital content across multiple client devices associated with one or more users. For example, a user may edit digital content using the client device 1206. The content management system 102 can cause the client device 1206 to send the edited digital content to the content management system 102. The content management system 102 then synchronizes the edited digital content on one or more additional computing devices.

In addition to synchronizing digital content across multiple devices, one or more embodiments of the content management system 102 can provide an efficient storage option for users that have large collections of digital content. For example, the content management system 102 can store a collection of digital content on the content management system 102, while the client device 1206 only stores reduced-sized versions of the digital content. A user can navigate and browse the reduced-sized versions of the digital content on the client device 1206. In particular, one way in which a user can experience digital content is to browse the reduced-sized versions of the digital content on the client device 1206.

Another way in which a user can experience digital content is to select a reduced-size version of digital content to request the full- or high-resolution version of digital content from the content management system 102. In particular, upon a user selecting a reduced-sized version of digital content, the client device 1206 sends a request to the content management system 102 requesting the digital content associated with the reduced-sized version of the digital content. The content management system 102 can respond to the request by sending the digital content to the client device 1206. The client device 1206, upon receiving the digital content, can then present the digital content to the user. In this way, a user can have access to large collections of digital content while minimizing the amount of resources used on the client device 1206.

The client device 1206 may be a desktop computer, a laptop computer, a tablet computer, a personal digital assistant (PDA), an in- or out-of-car navigation system, a handheld device, a smartphone or other cellular or mobile phone, or a mobile gaming device, other mobile device, or other suitable computing devices. The client device 1206 may execute one or more client applications, such as a web browser (e.g., MICROSOFT WINDOWS INTERNET EXPLORER, MOZILLA FIREFOX, APPLE SAFARI, GOOGLE CHROME, OPERA, etc.) or a native or special-purpose client application (e.g., FACEBOOK for iPhone or iPad, FACEBOOK for ANDROID, etc.), to access and view content over the network 1204.

The network 1204 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which the client devices 1206 may access the content management system 102.

In the foregoing specification, the present disclosure has been described with reference to specific example embodiments thereof. Various embodiments and aspects of the present disclosure(s) are described with reference to details discussed herein, and the accompanying drawings illustrate the various embodiments. The description above and drawings are illustrative of the disclosure and are not to be construed as limiting the disclosure. Numerous specific details are described to provide a thorough understanding of various embodiments of the present disclosure.

The present disclosure may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

What is claimed is:

1. A computer-implemented method comprising:
receiving audio data of a meeting;
identifying a user as a participant of the meeting;
in response to identifying the user as the participant of the meeting, determining one or more digital documents corresponding to the user; and
utilizing a digital transcription model to generate a digital transcript of the meeting based on the audio data and the one or more digital documents corresponding to the user.

2. The computer-implemented method of claim 1, wherein:
determining the one or more digital documents corresponding to the user comprises accessing a digital lexicon associated with the meeting; and
utilizing the digital transcription model to generate the digital transcript of the meeting comprises generating the digital transcript of the meeting based on the audio data and the digital lexicon associated with the meeting.

3. The computer-implemented method of claim 1, further comprising:
generating a digital lexicon associated with the meeting by analyzing the one or more digital documents corresponding to the user; and
wherein generating the digital transcript of the meeting is based on the audio data and the digital lexicon associated with the meeting.

4. The computer-implemented method of claim 1, wherein:
utilizing the digital transcription model to generate the digital transcript of the meeting comprises utilizing a trained digital transcription neural network to generate the digital transcript of the meeting; and
inputs to the trained digital transcription neural network comprise the audio data and the one or more digital documents corresponding to the user.

5. The computer-implemented method of claim 1, further comprising identifying the user as the participant of the meeting based on:
identifying a digital event item associated with the meeting; and
parsing the digital event item to identify the user as the participant of the meeting.

6. The computer-implemented method of claim 1, further comprising identifying the user as the participant of the meeting from a digital document associated with the meeting.

7. The computer-implemented method of claim 6, wherein the digital document associated with the meeting comprises a meeting agenda that indicates meeting participants, a meeting location, a meeting time, and a meeting subject.

8. The computer-implemented method of claim 1, further comprising:
accessing additional digital documents corresponding to one or more additional users that are participants of the meeting; and
wherein utilizing the digital transcription model to generate the digital transcript of the meeting is further based on the additional digital documents corresponding to one or more additional users that are participants of the meeting.

9. The computer-implemented method of claim 8, further comprising:
determining user features corresponding to the user; and
wherein utilizing the digital transcription model to generate the digital transcript of the meeting is based on the user features corresponding to the user.

10. The computer-implemented method of claim 9, wherein the user features corresponding to the user comprise a job position held by the user.

11. The computer-implemented method of claim 1, further comprising:
determining, from a collaboration graph, additional digital documents corresponding to the meeting; and
wherein utilizing the digital transcription model to generate the digital transcript of the meeting is further based on the additional digital documents corresponding to the meeting.

12. A non-transitory computer-readable storage medium comprising instructions that, when executed by at least one processor, cause a computer system to:
identify one or more digital documents associated with a user,
analyze the one or more digital documents to generate a digital lexicon associated with the user;
receive, from a client device, audio data of a meeting attended by the user;
access the digital lexicon associated with the user in response to identifying the user as a participant of the meeting; and
utilize a digital transcription model to generate a digital transcript of the meeting based on the audio data and the digital lexicon associated with the user.

13. The non-transitory computer-readable storage medium of claim 12, wherein the instructions cause the computer system to analyze the one or more digital documents to generate the digital lexicon associated with the user by:
parsing the one or more digital documents to identify words and phrases utilized within the one or more digital documents;
generating a distribution of the words and phrases utilized within the one or more digital documents;
weighting the words and phrases utilized within the one or more digital documents based on a meeting subject; and
generating the digital lexicon associated with the user based on the distribution and weighting of the words and phrases utilized within the one or more digital documents.

14. The non-transitory computer-readable storage medium of claim 12, further comprising instructions that cause the computer system to:
analyze the one or more digital documents to generate an additional digital lexicon associated with the user;
determine that the digital lexicon associated with the user corresponds to a first subject;
determine that the additional digital lexicon associated with the user corresponds to a second subject; and
based on determining that the meeting corresponds to the first subject, utilize the digital lexicon associated with the user to generate the digital transcript of the meeting.

15. The non-transitory computer-readable storage medium of claim 12, wherein the instructions cause the computer system to utilize the digital transcription model to generate the digital transcript of the meeting by:
identifying a portion of the audio data that comprises a spoken word;
detecting a plurality of potential words that correspond to the spoken word;
weighting a prediction probability of each of the potential words utilizing the digital lexicon associated with the user; and
selecting the potential word having the most favorable weighted prediction probability of representing the spoken word in the digital transcript.

16. A system comprising:
at least one processor; and
a non-transitory computer memory comprising instructions that, when executed by the at least one processor, cause the system to:
receive audio data of a meeting having multiple participants;
in response to receiving the audio data of the meeting, identify one or more digital documents corresponding to the meeting;
utilize a trained digital transcription neural network to generate a digital transcript of the meeting based on the audio data and the one or more digital documents corresponding to the meeting; and
provide the digital transcript of the meeting to a client device associated with a user.

17. The system of claim 16, further comprising instructions that cause the system to:
utilize the audio data of the meeting as a first input into the trained digital transcription neural network; and
utilize event details as a second input into the trained digital transcription neural network.

18. The system of claim 16, wherein the one or more digital documents corresponding to the meeting comprise a meeting agenda indicating a meeting time, meeting participants, and a meeting subject.

19. The system of claim 16, further comprising instructions that cause the system to train the digital transcription neural network by:
generating synthetic audio data from a plurality of digital training documents corresponding to a meeting subject utilizing a text-to-speech model;
providing the synthetic audio data to the digital transcription neural network; and
training the digital transcription neural network utilizing the digital training documents as a ground-truth to the synthetic audio data.

20. The system of claim 16, further comprising instructions that cause the system to:
receive, from a client device associated with the user, a request for a digital transcript;
determine an access level of the user;
redact portions of the digital transcript based on the determined access level of the user and audio cues detected in the audio data; and
wherein providing the digital transcript of the meeting to the client device associated with the user comprises providing the redacted digital transcript.
